(19) United States
(12) Patent Application Publication
(10) Pub. No.: US 2016/0078642 A1
(43) Pub. Date: Mar. 17, 2016

(54) METHOD AND APPARATUS TO CREATE AND CONSUME A WORKFLOW AS A VISUAL CHECKLIST

(71) Applicant: Properly, Inc., San Francisco, CA (US)

(72) Inventor: Alexander Nigg, San Francisco, CA (US)

(21) Appl. No.: 14/856,260

(22) Filed: Sep. 16, 2015

Related U.S. Application Data
(60) Provisional application No. 62/051,792, filed on Sep. 17, 2014.
(60) Provisional application No. 62/056,332, filed on Sep. 26, 2014.

(51) Int. Cl. G06T 11/00; G06F 3/0484; G06Q 10/06; G06F 3/0481

(52) U.S. Cl. CPC G06T 11/00; G06F 3/04817; G06F 3/04842; G06Q 10/0633; G06T 2210/61

(57) ABSTRACT

Disclosed are method and apparatus either of which enables a user who wants to communicate instructions for performing certain tasks (possibly in a specific way) to other people, to do so easily, precisely, and in detail. The technique enables the receiving party to easily consume, i.e., understand, follow, and communicate completion of, these instructions, while being able to communicate with the person who generated the instructions. As well, the technique generates an audit trail for the person who created the instructions. The person communicating the instructions for performing certain tasks can automatically track the completion of the tasks, as well as view analytics related to the tasks, their completion, and the actions of the person(s) performing them.

A portion of this patent document contains material that is subject to copyright protection. To the extent required by law, the copyright owner has no objection to the facsimile reproduction of the document, as it appears in the U.S. Patent and Trademark Office patent file or records, but otherwise reserves all copyright rights whatsoever.

This application claims the benefit of U.S. Provisional Patent Application No. 62/051,792, entitled “SYSTEM AND METHOD TO CREATE AND CONSUME A WORKFLOW AS A VISUAL CHECKLIST FOR A TOUCH-ENABLED DEVICE”, which was filed on Sep. 17, 2014, and claims the benefit of U.S. Provisional Patent Application No. 62/056,332, entitled “SYSTEM AND METHOD TO CREATE AND CONSUME A WORKFLOW AS A VISUAL CHECKLIST FOR A TOUCH-ENABLED DEVICE”, which was filed on Sep. 26, 2014, both of which are incorporated by reference herein in their entireties.

### BACKGROUND

A person communicating a series of tasks to be carried out often faces a number of challenges, including: complexity of the tasks (e.g., communicating what task(s) to do, to what object(s) to do these task(s), and how to do these tasks); replication of instructions (e.g., having to repeat all of the above when they need to have a different task-performer complete the same tasks); getting notified about the progress and completion of these tasks; being able to hear from the task-performer in real-time if there are issues arising from the attempt to complete the tasks; quality assurance and verification (i.e. verifying that the tasks are completed correctly); and tracking and analyzing data about the completion of various tasks by the same person, or by different people asked to complete the same or similar tasks. For instance, with regard to complexity, the home sharing or vacation cleaning processes are complicated towels, resupplying consumables (e.g., soap, shampoo, toilet paper, tissues, coffee, and tea), maintaining equipment (e.g., a pool, a hot tub, and coffee machines). The written instructions can be lengthy and time-consuming to write and compliance to such instructions can be low. A cleaner might not have received the instructions, might not have read the instructions, or might not have understood the instructions (e.g., due to language issues or other issues).

With regard to the repetition of instructions, it is known that cleaners for a particular property change frequently, as they are selected based on availability in ever-changing time slots. Thus, the host finds himself communicating the set of instructions for a cleaning job again and again.

With regard to quality assurance and verification, often a cleaner's performance is first seen by the guest, not the owner or property manager. Due to cleaner performance being highly variable and many cleaners working at a property for the first time, it is important for owners to be able to enforce and verify completion of required process steps. Favorable guest reviews are important to property occupancy levels and hence revenues. Also, adding guest amenities such as welcome gifts or cards have been known to have a strongly positive impact on reviews, but are hard to implement when a host is not present.

With regard to inventory and damage control, frequently the cleaner is the only person associated with the property owner who sees the property in between guest turnovers. Thus, it is incumbent upon the cleaner to communicate problems to the owner. Such problems can range from the mundane (e.g., out of toilet paper) to the serious (e.g., theft or damage to the property). Typically, in the home sharing environment, a host is required to report any problem to the home sharing platform within 24 hours of guest departure. If the host is not present, such reporting might only be possible when the cleaner reports the problem or when the host has documentation that the problem was not pre-existing.

### BRIEF DESCRIPTION OF THE DRAWINGS

One or more embodiments of the present invention are illustrated by way of example and not limitation in the figures of the accompanying drawings, in which like references indicate similar elements.

FIG. 1 is a sample screen shot of a sender view of a cleaning workflow prior to creation.

FIG. 2 is a sample screen shot of a receiver view of one image in a cleaning workflow.

FIG. 3 is a sample screen shot of a prompt for the receiver to take a verification image.

FIG. 4 is a sample screen shot of an embodiment of a login screen to register into the system.

FIG. 5 is a sample screen shot of an embodiment of a login screen depicting a user selecting the link to register into the system.

FIG. 6 is a sample screen shot of an embodiment of a text box to enter the email or phone number to which a corresponding invite was sent.

FIG. 7 is a sample screen shot of an embodiment of a sign up screen when creating an account.

FIG. 8 is a sample screen shot of an embodiment of a completed sign up screen where the user is selecting the button to create the account.

FIG. 9 is a sample screen shot of an embodiment of a job request screen in which the Accept button is selected.

FIG. 10 is a sample screen shot of an embodiment of an inbox screen showing the job request has been accepted.

FIG. 11 is a sample screen shot of an embodiment of an inbox screen showing notifications of a job requested, an inquiry, and that a job has been accepted.

FIG. 12 is a sample screen shot of an embodiment of a jobs screen showing a pictorial representation of jobs listings.

FIG. 13 is a sample screen shot of an embodiment of a jobs screen showing a list view link is being selected.

FIG. 14 is a sample screen shot of an embodiment of a full view of jobs.

FIG. 15 is a sample screen shot of an embodiment of a full view link being selected.

FIG. 16 is a sample screen shot of an embodiment of a pictorial job view being selected.

FIG. 17 is a sample screen shot of an embodiment of a notes view being selected for a view job screen.

FIG. 18 is a sample screen shot of an embodiment of a notes screen.

FIG. 19 is a sample screen shot of an embodiment of a contact link being selected for a view job screen.

FIG. 20 is a sample screen shot of an embodiment of a contacts screen.

FIG. 21 is a sample screen shot of an embodiment of a street address link being selected for a view job screen.

FIG. 22 is a sample screen shot of an embodiment of a map corresponding to a street address that was selected.

FIG. 23 is a sample screen shot of an embodiment of a view job link being selected for a particular street address.

FIG. 24 is a sample screen shot of an embodiment of a start job screen from the cleaner perspective.

FIG. 25 is a sample screen shot of an embodiment of a cleaner having started the job.

FIG. 26 is a sample screen shot of an embodiment of the timeline icon being selected by a cleaner.

FIG. 27 is a sample screen shot of an embodiment of a timeline as selected by a cleaner.

FIG. 28 is a sample screen shot of an embodiment of a cleaner being returned to the main screen after closing the timeline.

FIG. 29 is a sample screen shot of an embodiment of the cleaner selecting a contact owner icon.

FIG. 30 is a sample screen shot of an embodiment of a contact owner screen.

FIG. 31 is a sample screen shot of an embodiment of a report problem icon being selected by a cleaner.

FIG. 32 is a sample screen shot of an embodiment of a report problem screen in which a cleaner can describe the problem by typing.

FIG. 33 is a sample screen shot of an embodiment of a cleaner selecting a vacuuming icon.

FIG. 34 is a sample screen shot of an embodiment of the vacuuming icon in a different color to depict that the task is complete.

FIG. 35 is a sample screen shot of an embodiment of a cleaner having selected a clean icon with a note indicator, as depicted by an attached+icon.

FIG. 36 is a sample screen shot of an embodiment of a note pop-up indicating to clean glass with a particular cleaner.

FIG. 37 is a sample screen shot of an embodiment of a done button being selected on the note.

FIG. 38 is a sample screen shot of an embodiment of a different vacuum icon being selected.

FIG. 39 is a sample screen shot of an embodiment of the different vacuum icon in a different color, depicting that the related task is complete.

FIG. 40 is a sample screen shot of an embodiment of a take photo screen, which is shown in response to all tasks being completed.

FIG. 41 is a sample screen shot of an embodiment of the screen from which the cleaner takes a picture, the picture providing evidence that the tasks are completed.

FIG. 42 is a sample screen shot of an embodiment of a sender's dashboard 4200 displaying an in progress screen.

FIG. 43 is a sample screen shot of an embodiment of an in progress screen displaying a user input field and data indicating that one problem has been reported.

FIG. 44 is a pictorial flow diagram of creating a workflow from the property owner perspective according to an embodiment, the flow diagram depicting various functionalities and various relationships therein, e.g., adding a job, assigning a job, and editing a property address.

FIG. 45 is a sample screen shot of an image in a cleaning workflow 5400 from the receiver's perspective and viewed in landscape mode.

FIG. 46 is a sample screen shot of an image in a cleaning workflow when viewed in portrait mode, which shows at the top an image similar to that in FIG. 54 followed by items in a traditional checklist format.

FIG. 47 is a high-level block diagram showing an example of a processing system in which at least some operations related to a workflow process can be implemented.

FIG. 48 illustrates an environment in which workflow process technology can be implemented.

FIG. 49A-C illustrates an example of a workflow process from discovering the workflow application to completion of a job.

### DETAILED DESCRIPTION

References in this description to “an embodiment”, “one embodiment”, or the like, mean that the particular feature, function, structure or characteristic being described is included in at least one embodiment of the present invention. Occurrences of such phrases in this specification do not necessarily all refer to the same embodiment. On the other hand, the embodiments referred to also are not necessarily mutually exclusive.

Introduced here is a technique that enables quick and efficient creation and consumption of instructions for performing certain sets of tasks (“workflows”) each depicted by a visual checklist on a device. The technique enables transmission of complex task sequences in an easy-to-read visual format. It enables monitoring of the completion of the assigned tasks in real-time and archiving of completed tasks for compliance purposes or for performance analysis, for instance either comparing task completion across multiple task recipients or for the same recipient over multiple instances of workflow completion.

According to the technique introduced here, a user can import into a device a picture depicting a context of an area where one or several tasks are to be performed. The device can be either a stationary or mobile computing device, including mobile phone, tablet, wearable, head-up display (e.g., Google Glass or Microsoft HoloLens), or another device intended to convey information to its user. The picture can be any of or any combination of a photo, a diagram, a map, or a screen shot or any type of image. The technique includes a user interface containing one or more imported pictures, each paired with a series of predetermined user input images (e.g., icons), each user input image depicting a task related to the specified workflow. For instance, for a house-cleaning workflow, a set of icons can be provided, each icon depicting tasks such as vacuum, mop, wipe, and dust. As another example, for a painting workflow, such icons can depict tasks such as sand, strip, and paint. The technique enables a user to drag and drop a user input image onto the surface depicted in the picture where the task is to be performed or an object to which the task is to be performed. For example, a vacuum task icon can be dropped onto the surface rug in an image previously imported that depicts a room containing a rug. Each user input image is configured to be identified visually as containing additional information, which can be displayed via a pop-up window. The additional information contains instructions further explaining or modifying the task. For example for a cleaning workflow, the wipe task referencing the tabletop surface can include additional information such as using a particular cleaning supply. As another example for a painting workflow, additional information can refer to a brand name for a gallon of paint. Each user input image includes one or more states, e.g., completed, uncompleted, not yet commenced, in progress.

The technique enables the user to save and name the workflow. The user can then invite the receiving user (also referred to herein as the task-performing user) to accept a job request by transmitting the workflow via a link to the receiving user, for example through email, text message, or other transmission methods. The receiving user starts the workflow by selecting a start indicator which causes a notification that the job has started to be sent for delivery to the user. The receiver views the step details and checks the icons off progressively. The receiving user of the workflow can change the state of the user input image from uncompleted to completed by a command such as a touch command. The visual designation of each user input image changes as its state changes, for example by changing color or other visual designation. The technique enables the change of state of user input images to be recorded. As well, the technique appends to the recorded data metadata such as time, date, and location information to each change in state. When a change of state of the user input image occurs the technique enables the user, i.e., sender of the workflow, to be notified of the change of state. The user can be notified for each task in real-time or in batch format.

When the receiving user has completed all tasks of the workflow, the receiving user can be required to take a picture allowing for visual verification of steps completed. The verification can be optional or required. When required, the user can designate where in the workflow to require the verification. The verification can be triggered by time of day, time elapsed, location of the device used by the receiving user, completion of certain steps, or any combination of the above.

Based on the recorded data, the technique enables comparing task completion for the same workflow between different receiving users or for the completion of the same workflow multiple times by the same receiving user. Such comparison of data can be used in performance analysis of the individual completing the series of tasks.

With regard to the complexity of creating a workflow, the technique simplifies such process, because for a user the technique of creating a job is quick, fun, intuitive, effective, and easily adopted by the recipient of the workflow.

With regard to the repetition problem, with the technique any existing workflow is easily modifiable. The workflow can be created once used n times. A user can create minor variations easily. That is, the technique easily allows modifications to a basic flow. For example, from a basic cleaning workflow, a user can create a basic+laundry workflow or a basic+exterior windows workflow.

With regard to the quality assurance and verification problem, the technique has built in quality assurance and verification steps without alienating the receiver of the workflow and without cluttering the display. For example, because the technique automatically tracks time, location, order and timing of completion, and level of detail viewed, such collection of data is done without being obvious to the receiver of the workflow. In addition, the technique can cause the user interface of the device to display the summary results to the sender of the workflow only in real-time, as well as archived such data in a history archive.

With regard to the inventory and damage control problem, the technique makes problem reporting easy and intuitive, quick, fun, and rewarding for the cleaner.

### Some Embodiments

The technique supports parties in addition to the sending user (also referred to herein as the task-setting user) and the receiving user, such as property managers and owners parties where both see different views, e.g., on progress and history. Another example combination of parties includes cleaning franchises, cleaning companies, cleaners, and owners or property management companies. In this case, the embodiment includes a permission system and access system to support granular billing and pricing models.

The technique also supports that the receiving device is the same as the originating device. For instance, a user can create a workflow for themselves and then consume (i.e., perform) the workflow themselves, possibly on the same device. An example use case is when the user wants to create the workflow as a reminder to perform (consume the workflow including) a task. Also, as another example, the user can create and consume the workflow as an act of compliance, such as to document having followed a certain procedure.

Certain embodiments can include service functions for the following surfaces: gardening, landscaping, pool, spa maintenance, snow removal, gutter cleaning, etc. Certain embodiments can include functions for the industrial, commercial and institutional cleaning environments (e.g., offices, schools, hospitals, and factories). Any commercial process flow can be implemented by the technique, such as retail (store opening and closing, merchandising, stock management), field service (e.g., telecom, cable, construction management, and trades), franchise management and any standard operating procedure.

In another embodiment, the technique can be configured to support guest welcome, house orientation, review management, owner-property management, and guest communications.

The technique can be integrated with other services, such as property management platforms (e.g., Superhost, Airenvy), lock management (e.g., August, Lockitron) home sharing platforms (e.g., Airbnb, HomeAway, 9Flats, Wimdu, Flipkey), and cleaning platforms (e.g., Homejoy, Handybook, and Exec). Integration with delivery/logistics platforms for resupply is also enabled. Examples of such platforms include, resupply of guest welcome and cleaning supplies (e.g., via Google Shopping Express, Amazon Fresh, Safeway Now, eBay Now).

An alternative embodiment displays information that combines the visual checklist with the traditional checklist. For example, when being viewed in landscape mode, the display on either the originating device or the receiving device is configured to show items on top of the image. When flipped to portrait mode, the display is configured to show the same image at the top followed by some items in the traditional checklist format (possibly taking up more than one screen and thus require scrolling). Some items can also include other contextual information, such as more detailed instructions, other items on overall checklist that may or may not be related to that image but provide additional context, or photos taken or notes made by an operator.

Another alternative embodiment enables a workflow to be created as a guestbook and local area guide with guests in the hospitality environment. With the embodiment, a guest can have a guide to the home on their device prior to an arrival. Such provision can simplify several tasks. Directions to the house and house access instructions are available prior to arrival and can be used with map integrations. House instructions and other related data can be updated on-the-fly, integrated with images (e.g., how to use a coffee machine, entertainment options, Wi-Fi availability), and integrated with a messaging host. The local area guide portion can be integrated with maps and directions, and other features such as restaurant recommendations. For example the technique can enable integrating with OpenTable.

In parts of the remaining description, the example of a cleaning workflow is discussed for illustrative purposes only, to explain various aspects of the technique.

Use Case—Cleaning Workflow

Aspects of the technique can be understood through the description of a cleaning workflow embodiment. Via this embodiment, a quick, structured, intuitive and effective building of a cleaning workflow, through a visual checklist is achieved.

A preset structure consisting of sequential sections is provided to the user, who wants to create a cleaning workflow: 1. Access and Orientation: how to get into the property and where to find what, e.g., keys, lockboxes, codes, spare linen, cleaning supplies etc. 2. Preparation: how to strip/make beds, exchange towels, do dishes, do laundry, prepare a guest welcome card and gift, etc. 3. Cleaning: how to clean the property: cleaning what surface, how, and using what device/cleaning supply. 4. Finishing: how to finish: how to lock the property, present the property (e.g., which lights are to be switched on and off and which curtains drawn), and complete final checklists (e.g., refill soap and other supplies, water plants, etc.).

Actual images of the property to be cleaned are used. The images are either imported from an existing photo library (for example and Airbnb listing photo gallery) or added via a camera. Images can be wide angle or panoramic shots of a room providing visual context.

A set of task icons representing tasks associated with each section is available to the user on the display. Such task icons enable quick and intuitive visual association by allowing the user to drag and drop a particular task icon onto a surface where the task is to be performed. Examples of such tasks include water plant and wipe glass table.

The embodiment is configured to provide an optional detail level, where desired, for the creator of the workflow to add a modifier to further explain the task. For example, the additional information can include “water plant with half a gallon of water” or “wipe glass table using my favorite brand”.

The embodiment enables the quick building of variations of the same cleaning flow using copy and paste, for example, the core cleaning job, the core cleaning job+clean oven, and the core cleaning job+clean window exterior.

The visual checklist is configured to enable the quick and easy checking off of items on the visual checklist. As an item is checked, meaning the task is complete, the embodiment causes the host to receive effective real-time feedback. Such embodiment helps in ensuring that all items are completed, because the cleaner knows that the creator of the workflow knows when a task is completed. The embodiment is configured to display real-time progress data, such as a real-time progress bar, for the creator of the workflow to understand at a glance whether cleaning will be completed on time. With such data, the embodiment supports benchmarking of cleaner performance and provides granular analytics as to whether sufficient time is allocated to each task.

The embodiment enables real-time contextual communication between the creator of the workflow and the cleaner. Such communication can structured or unstructured. An example of implementing structured communication can be to proactively prompt communication for example to ensure that the cleaner reports a problem. Unstructured communication can be used for all other communication.

The embodiment enables the creation of an audit trail via completed checklists and verification pictures to enforce and document the workflow processes, to manage liability (e.g., changing chemicals in the hot tub or sanitizing the bathroom), and to support host claims in case of guest damage or theft.

An embodiment of the technique includes a software application (“application”) used by a stationary personal computing device or by a mobile computing device (“device”) such as for example a mobile device (e.g., phone and tablet) running iPhone OS (iOS) or Android, or a head-up display. Such application supports both a sender of the workflow, e.g., the host, and a receiver of the workflow, e.g., the cleaner. In the following descriptions, the structure, functionality, and features of the application are illustrated in the context of a cleaning workflow. Note that employing the cleaning workflow is for illustrative purposes only.

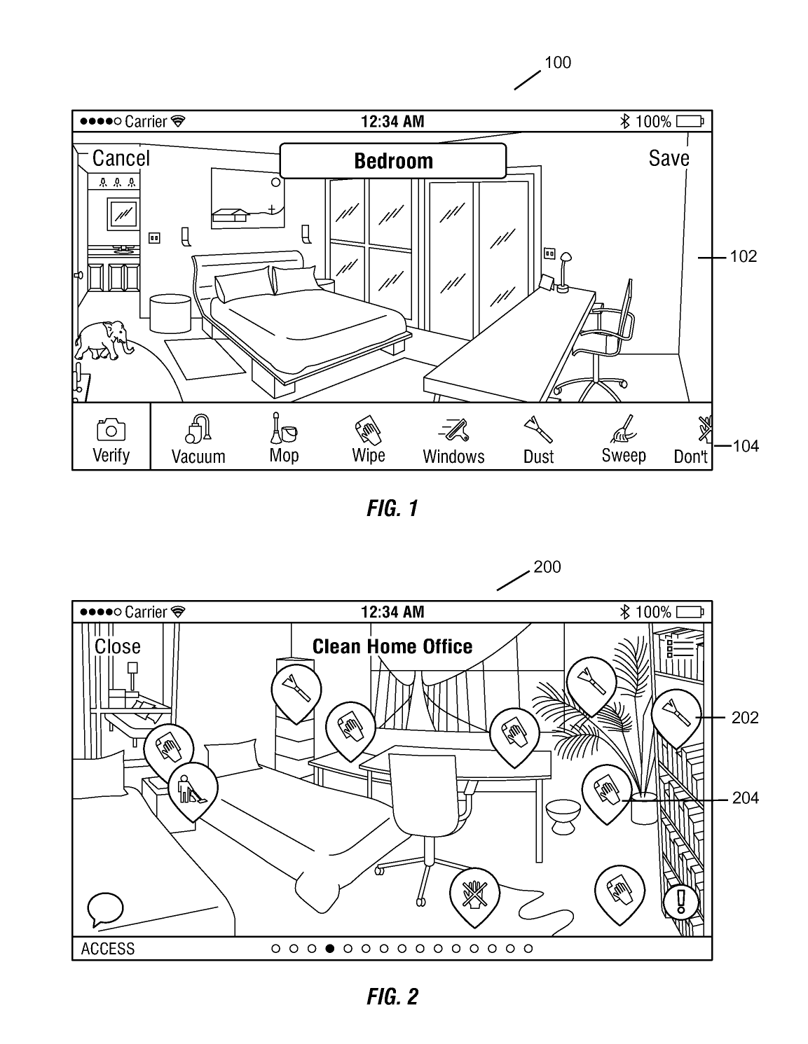

FIG. 1 is a sample screen shot of a sender user (“sender” or “task-setting user”) view 100 of a cleaning workflow prior to creation. Image 102 is the job area where cleaning is to be performed. Here, image 102 depicts a bedroom that the sender wants cleaned. Overlaying image 102 at the bottom in a task icon bar 104 is a set of task icons that correspond to cleaning a room. Each task icon in task icon bar 104 can be dragged and dropped one or multiple times onto any surface depicted in image 102, as desired by the sender. Examples of the task icons include verify, vacuum, and mop.

FIG. 2 is a sample screen shot of a receiving user (“receiver” or “task-performing user”) view 200 of one image in a cleaning workflow. Icons in a first color (e.g., red) depict tasks not yet completed. Icons in a different color (e.g., green) depict tasks that have been completed. For example, task icon 202 is red, indicating that dusting the bookshelves has not yet been completed. Task icon 204 is green, indicating that wiping the palm leaves of the plant has been completed.

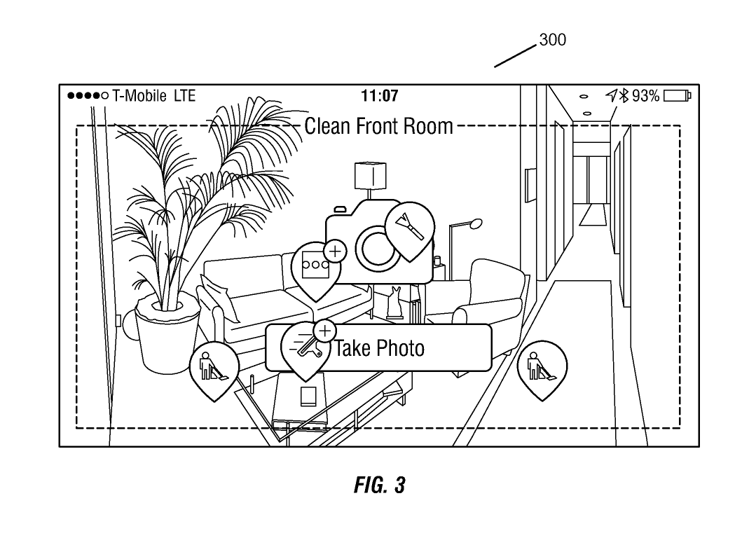

FIG. 3 is a sample screen shot of a prompt 300 for the receiver to take a verification image.

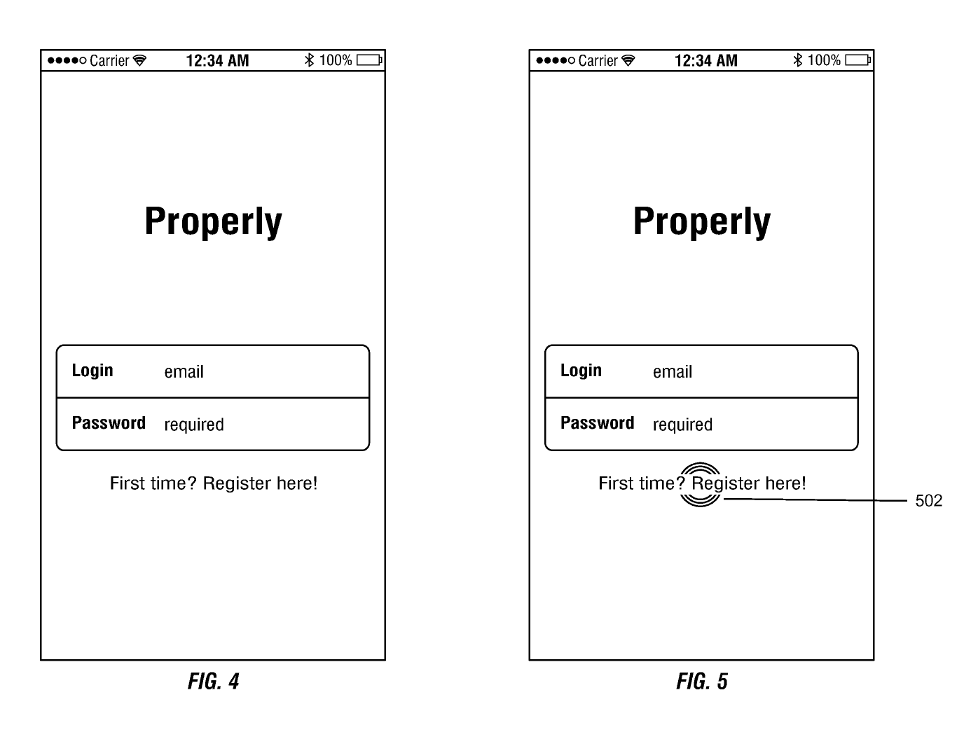

FIG. 4 is a sample screen shot of an embodiment of a login screen to register into the system. For example, the receiver would want to register for the application so that he can accept a job request from the sender.

FIG. 5 is a sample screen shot of an embodiment of the login screen of FIG. 4, depicting the receiver selecting the link 502 to register into the application.

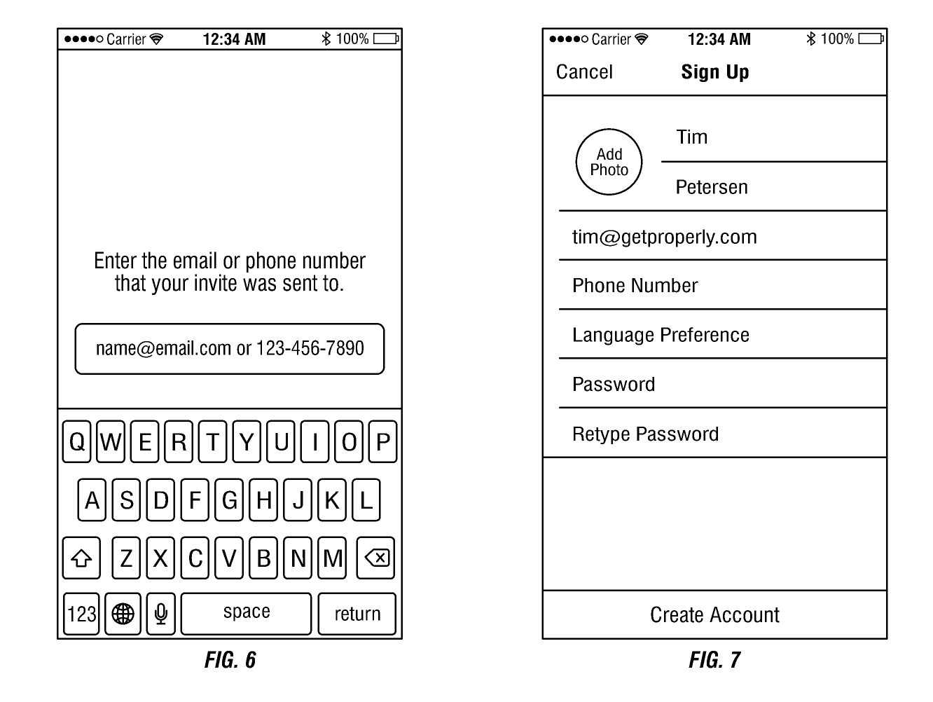

FIG. 6 is a sample screen shot of an embodiment of a text box to enter the email or phone number to which a corresponding invite was sent. For example, after the receiver completes registration for the application, the receiver enters either the email or the phone number of where he received the invitation from the sender so that the application can transmit future communications to that email address or phone number (e.g., text messages).

FIG. 7 is a sample screen shot of an embodiment of a sign up screen when creating an account within the application.

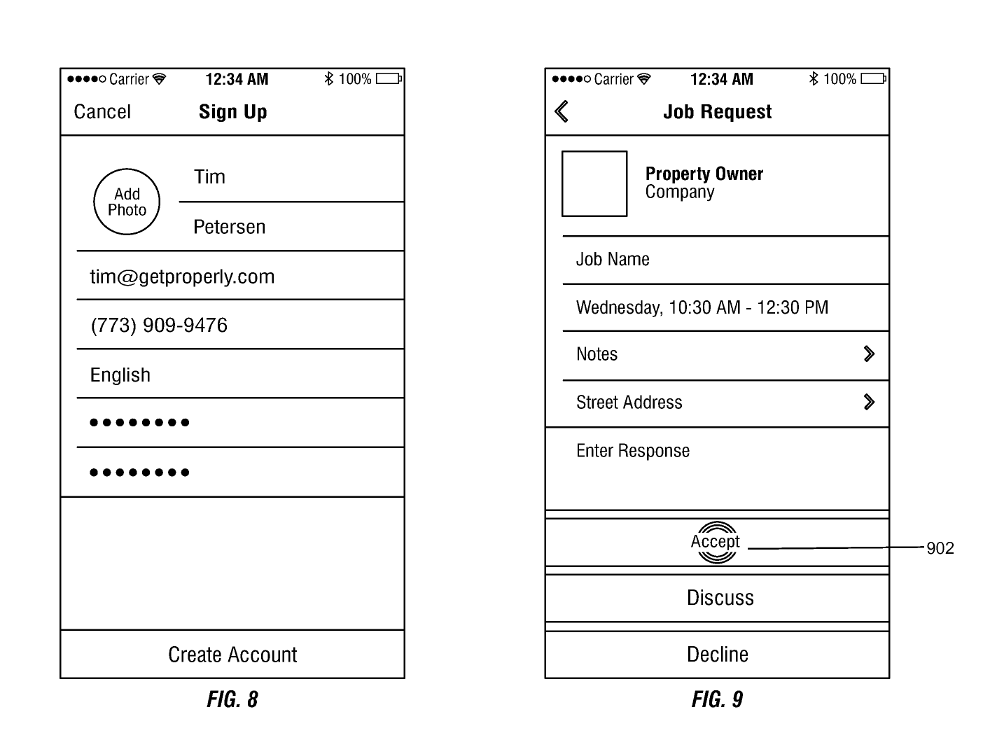

FIG. 8 is a sample screen shot of an embodiment of a completed sign up screen where the user is selecting the button to create the account.

FIG. 9 is a sample screen shot of an embodiment of a job request screen 902 on which the receiver selects the Accept button to accept the job request.

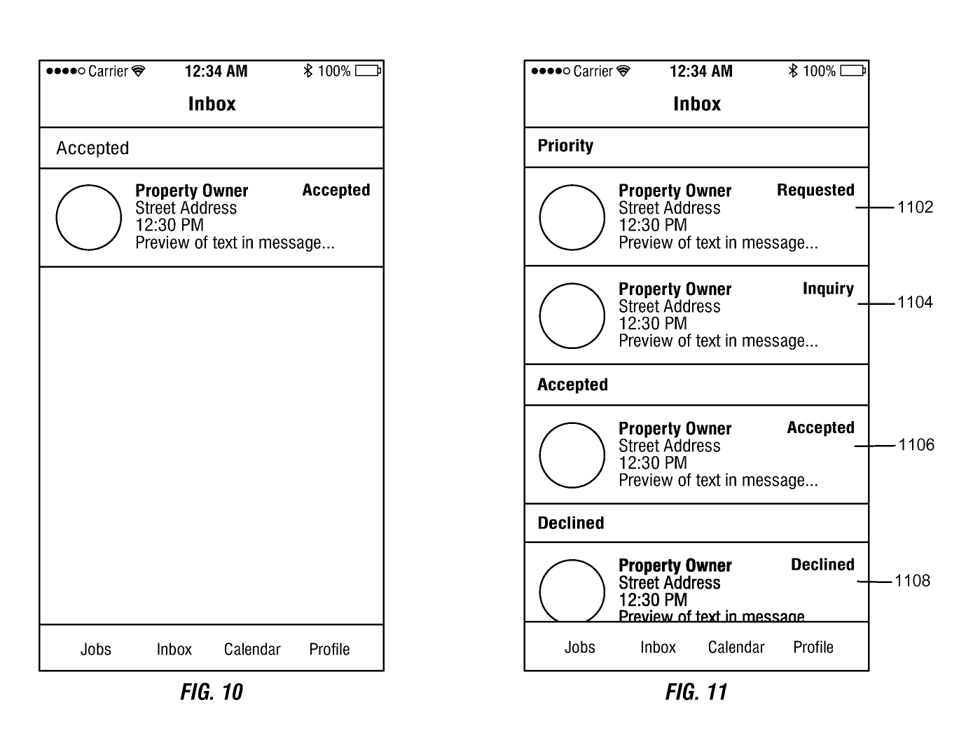

FIG. 10 is a sample screen shot of an embodiment of an inbox screen from the receiver perspective showing the job request has been accepted.

FIG. 11 is a sample screen shot of an embodiment of an inbox screen from the receiver perspective showing for example a notification of a job requested 1102, an inquiry (e.g., the receiver had a question about a task and sent a message with an inquiry about the task destined for the sender) 1104, that the receiver has accepted a job request 1106, and that the receiver has declined a job request 1108.

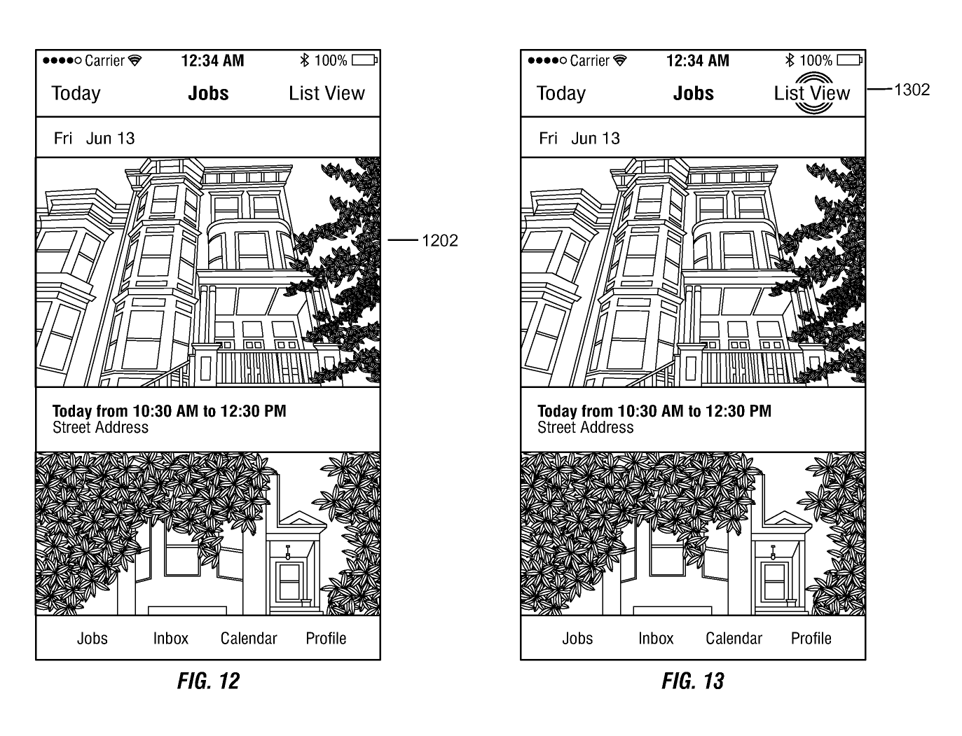

FIG. 12 is a sample screen shot of an embodiment of a jobs screen showing a pictorial representation of an accepted job request 1202.

FIG. 13 is a sample screen shot of an embodiment of a jobs screen showing a list view link is being selected 1302.

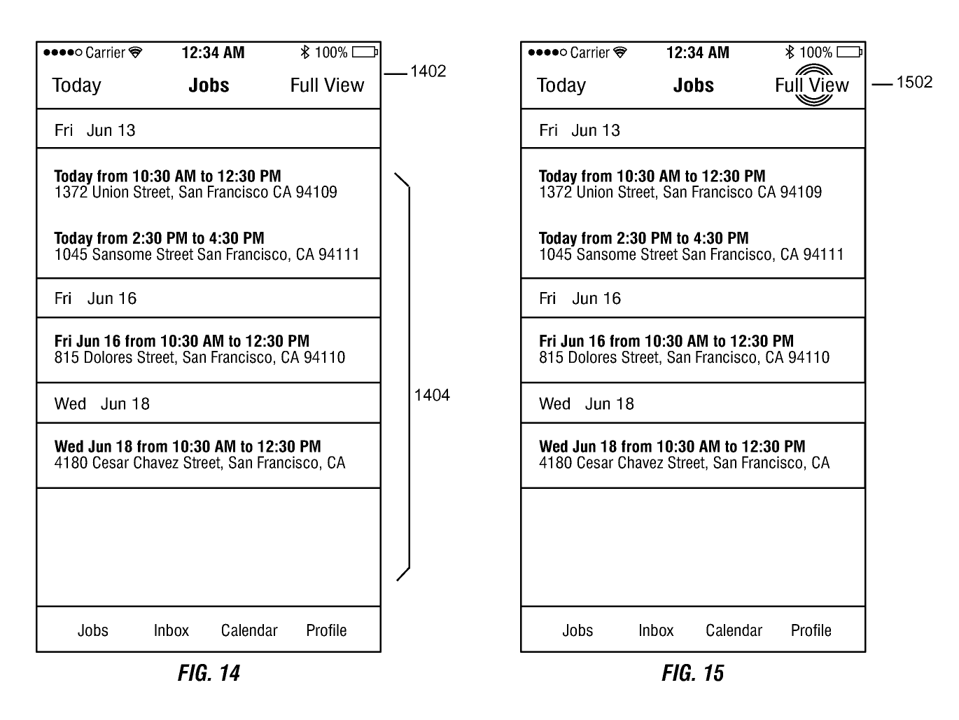

FIG. 14 is a sample screen shot of an embodiment of a full view 1402 of jobs accepted by the receiver. Here, the receiver can see at a glance that he has for upcoming jobs, displayed in a list 1404.

FIG. 15 is a sample screen shot of an embodiment of a full view link being selected 1502.

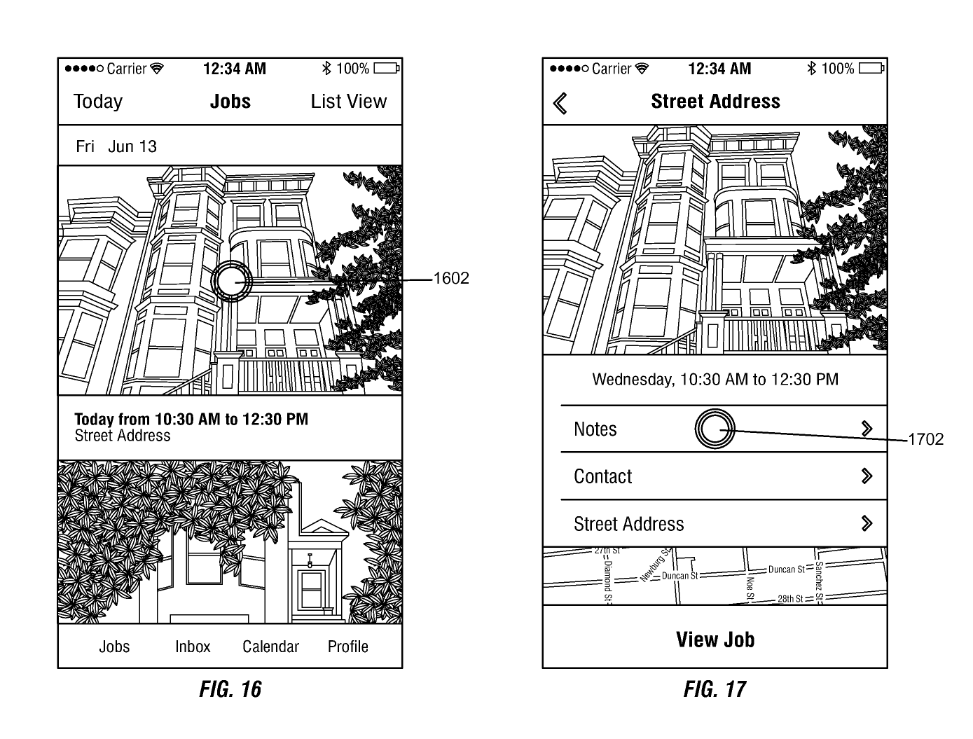

FIG. 16 is a sample screen shot of an embodiment of the full view in which the receiver selects the job request 1602 to see the job details.

FIG. 17 is a sample screen shot of an embodiment of a notes link being selected 1702 for a view job screen, for example, for the receiver to read any note written by the sender.

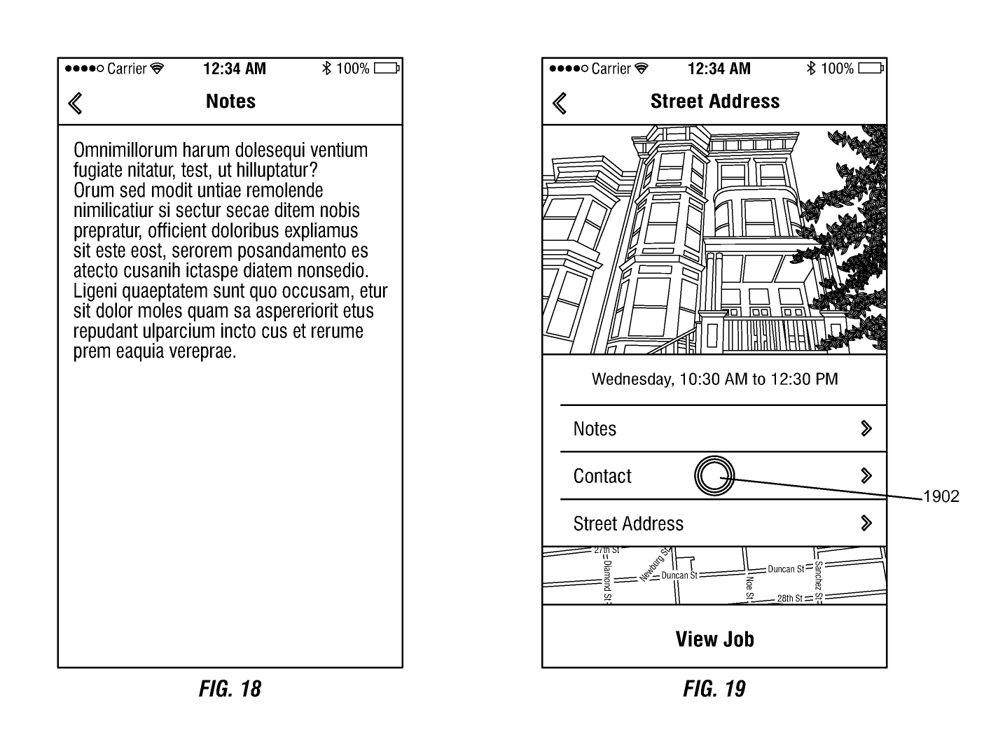

FIG. 18 is a sample screen shot of an embodiment of the notes screen selected in FIG. 17.

FIG. 19 is a sample screen shot of an embodiment of a contact link being selected 1902 for a view job screen. For example, the receiver wants to contact the property owner to communicate an issue.

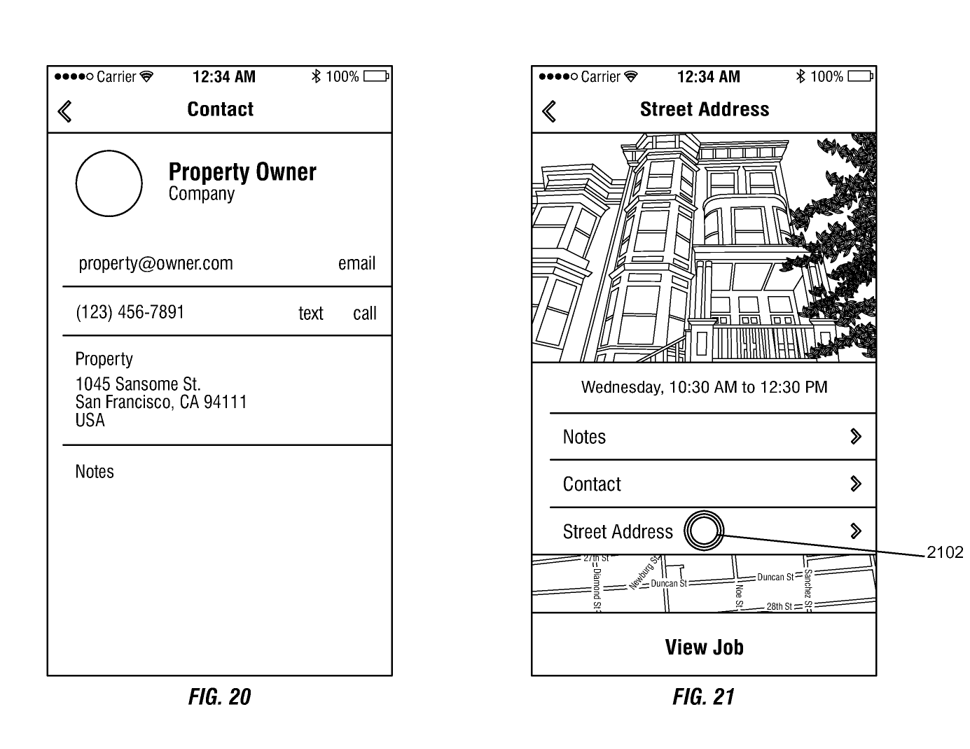

FIG. 20 is a sample screen shot of an embodiment of the contacts screen selected in FIG. 19.

FIG. 21 is a sample screen shot of an embodiment of a street address link being selected 2102 for a view job screen.

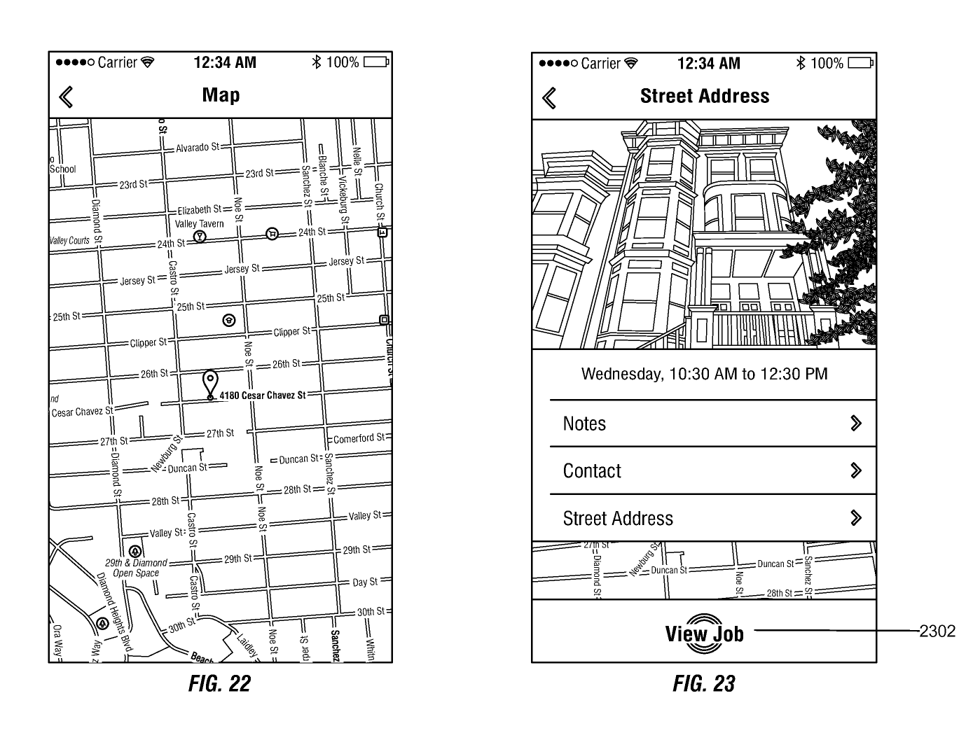

FIG. 22 is a sample screen shot of an embodiment of a map corresponding to a street address that was selected, such as for example the street address link in FIG. 21.

FIG. 23 is a sample screen shot of an embodiment of a view job link being selected to 2302 for a particular street address. Here, the receiver desires to view the job to begin performing the job.

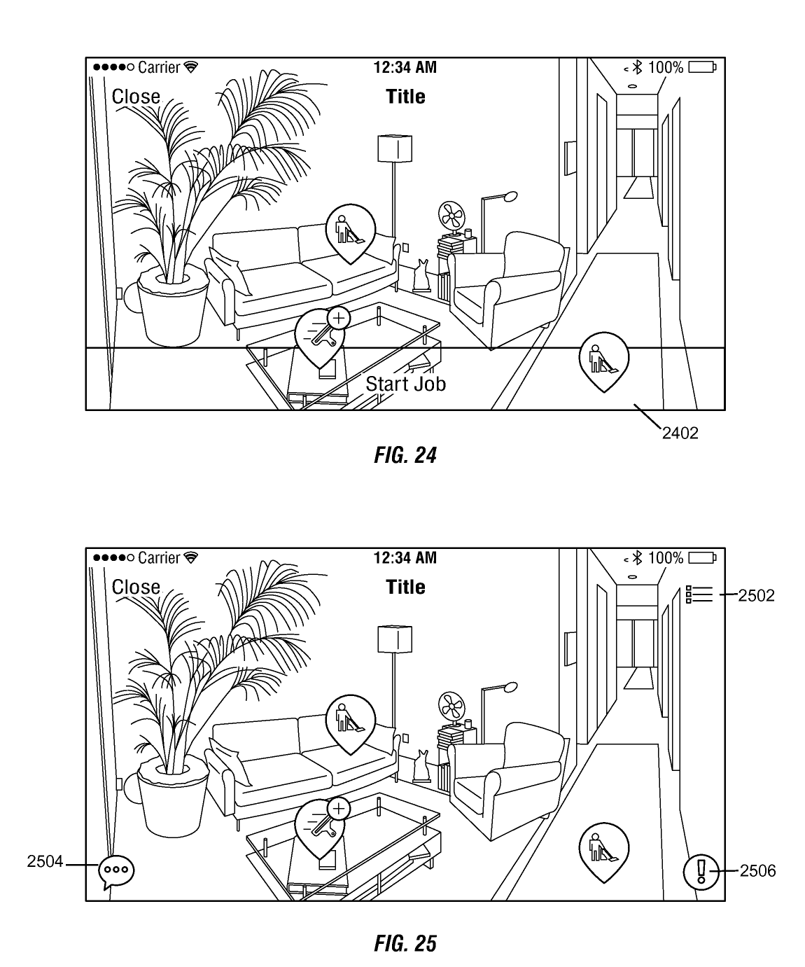

FIG. 24 is a sample screen shot of an embodiment of a start job screen from the receiver perspective. Overlaid on the first image of the job is a user input image, which the receiver is required to select before beginning the job process. Depicted here is a selectable bar labeled Start Job 2402. After the receiver presses the start job bar, the application causes a start notification message to be sent destined for the sender. Upon receiving the start notification message, the sender knows that the cleaning job has begun. Once the receiver has pressed the start job bar, the application causes the bar to disappear from the view.

FIG. 25 is a sample screen shot of an embodiment of a cleaner having started the job. The application causes three user input interfaces to be displayed: a timeline icon 2502, a contacts icon 2504, and a report problem icon 2506.

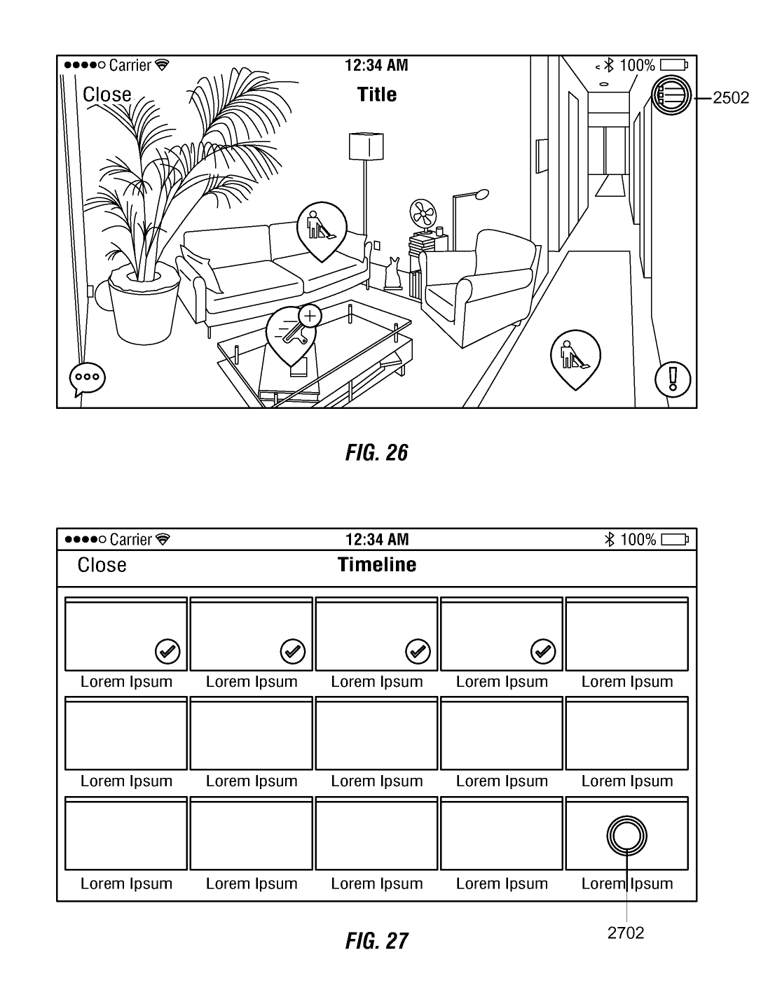

FIG. 26 is a sample screen shot of an embodiment of the timeline icon being selected to 2502 by the receiver.

FIG. 27 is a sample screen shot of an embodiment of a timeline of tasks as selected by a receiver, e.g., the timeline selected in FIG. 26. An individual entry of the timeline can be selected as shown 2702. Once selected, details about the task are displayed, for example, the estimated time of the start of the task and the estimated time of the duration of the task.

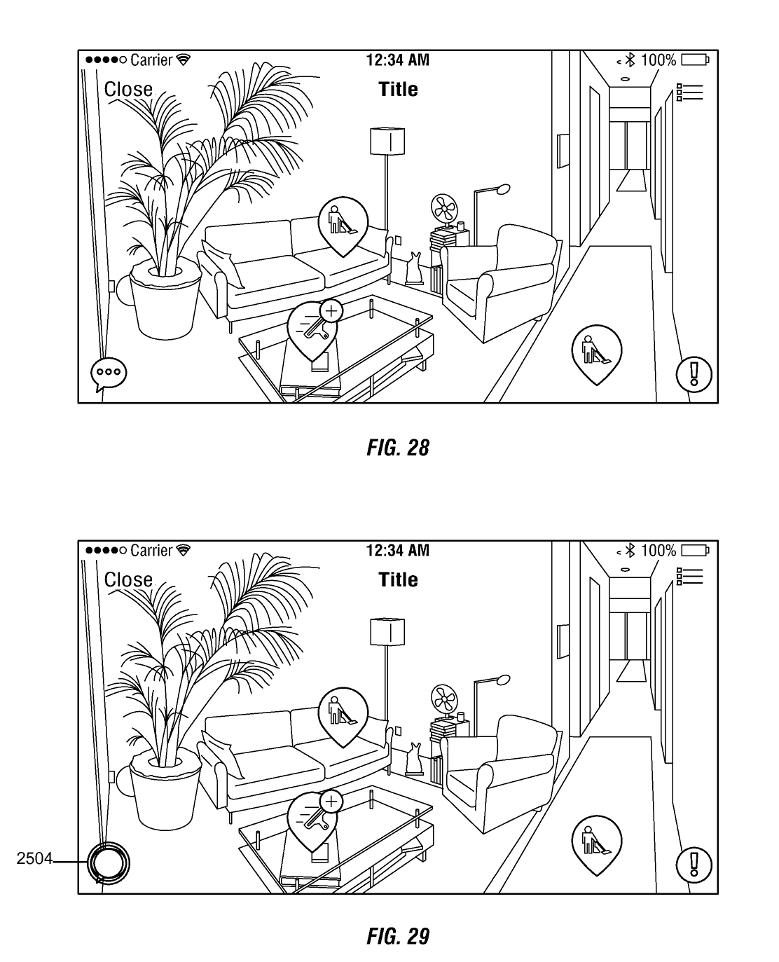

FIG. 28 is a sample screen shot of an embodiment of the receiver being returned to the main screen after closing the timeline.

FIG. 29 is a sample screen shot of an embodiment of the receiver selecting the contact icon 2504.

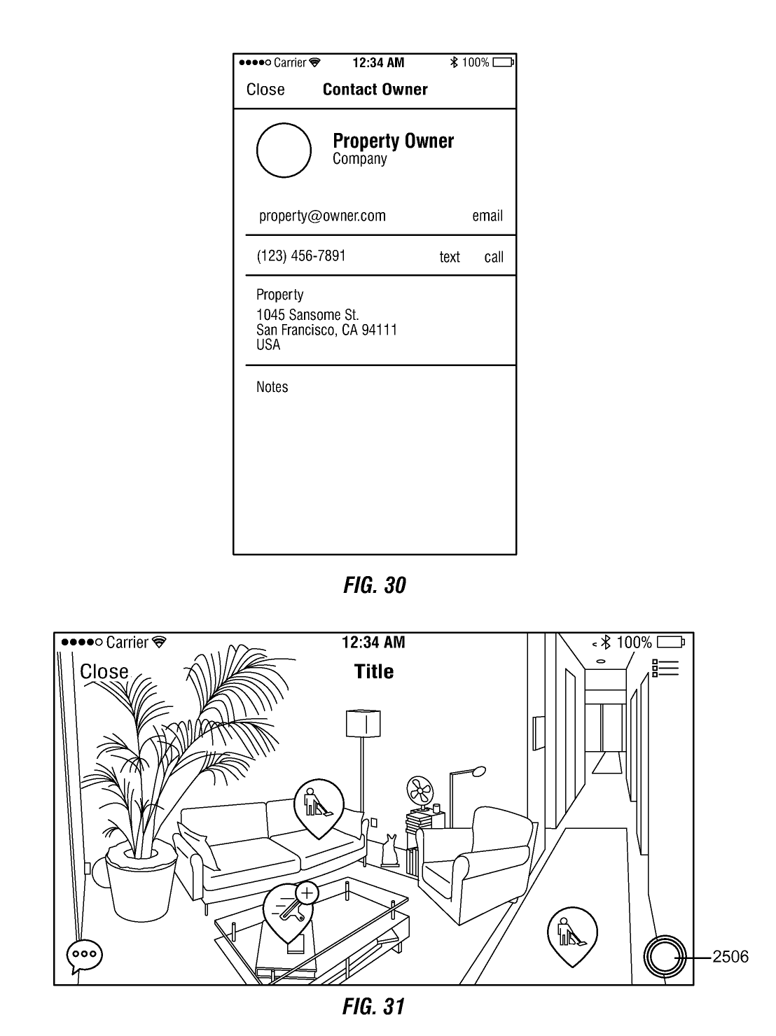

FIG. 30 is a sample screen shot of an embodiment of a contact owner screen. For example, the application causes this contact owner screen to be displayed in response to contact icon 2504 being selected in FIG. 29.

FIG. 31 is a sample screen shot of an embodiment of a report problem icon being selected to 2506 by the receiver.

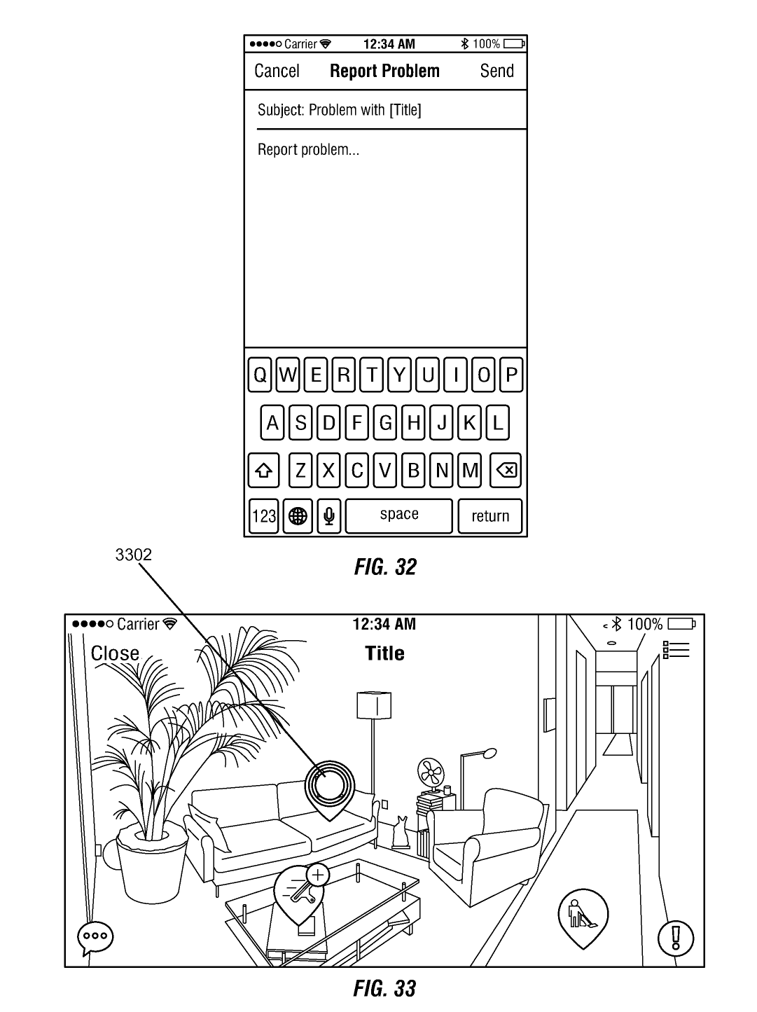

FIG. 32 is a sample screen shot of an embodiment of a report problem screen in which a receiver can describe the problem by typing text in a free-form or structured form. The application is configured to enable the receiver to attach a photograph related to the problem, as well. For example, the application causes this report problem screen to be displayed in response to report problem icon 2506 being selected by the receiver.

FIG. 33 is a sample screen shot of an embodiment of the receiver selecting a vacuuming icon 3302. Selecting such icon causes the application to change a state of the icon, for example from uncompleted to completed. For instance, the receiver clicked vacuuming icon 3302 to indicate he completed vacuuming the surface over which the icon is displayed.

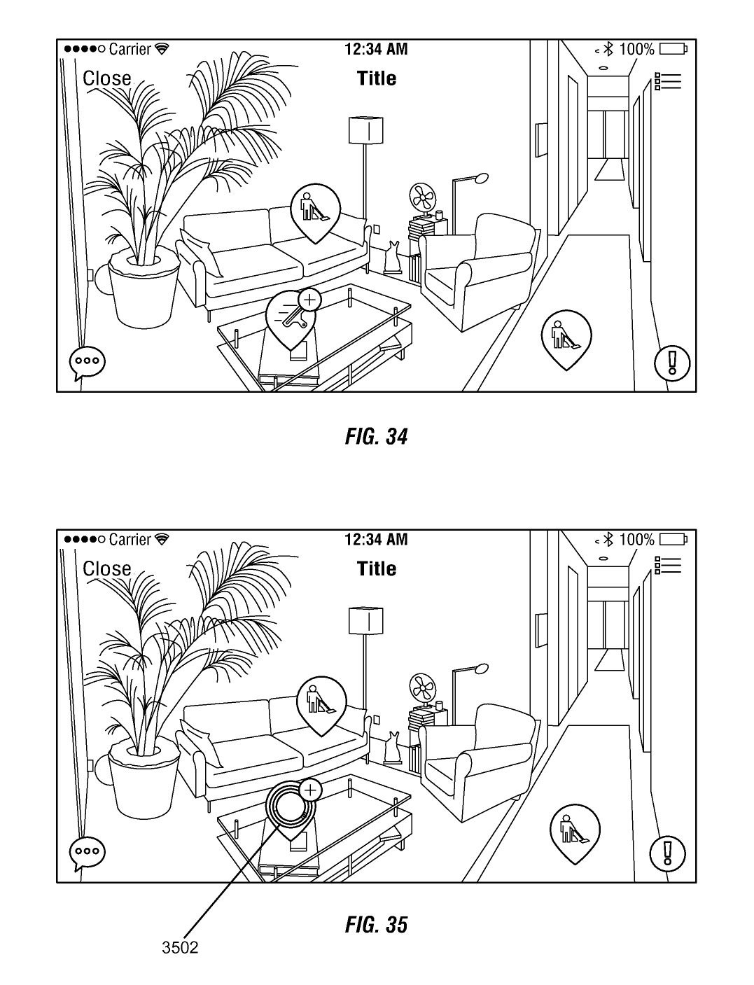

FIG. 34 is a sample screen shot of an embodiment of the vacuuming icon in a different color than the other two icons to depict that the task is complete.

FIG. 35 is a sample screen shot of an embodiment of the receiver having selected a clean glass icon coupled with a note indicator 3502, as depicted by an attached+icon.

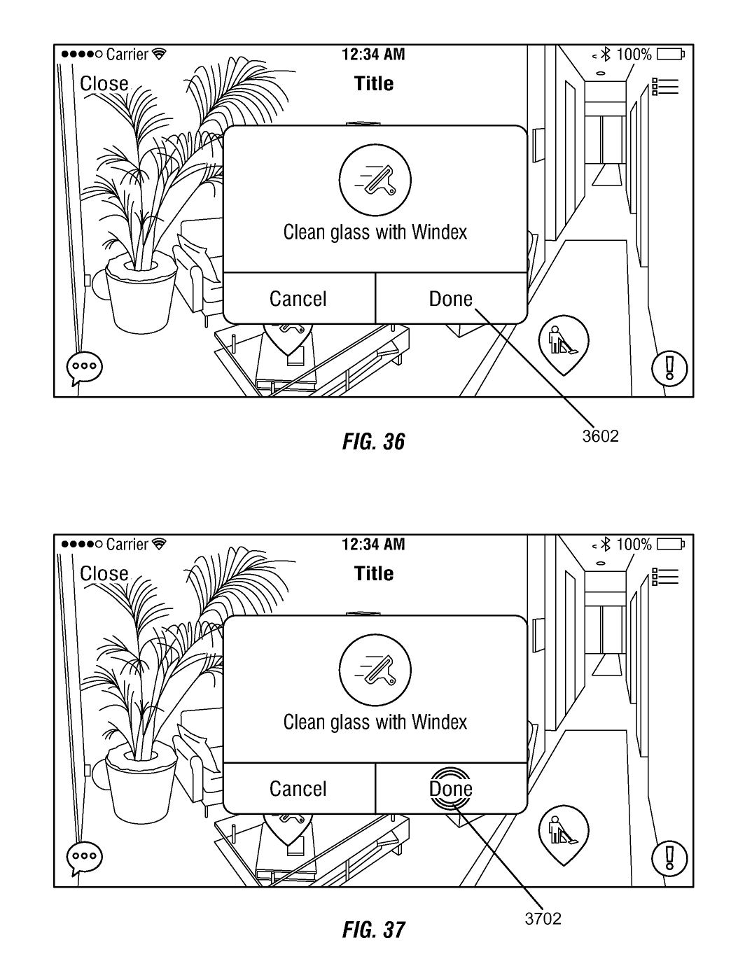

FIG. 36 is a sample screen shot of an embodiment of a note pop-up 3602 indicating to clean glass with a particular cleaner. For example, note pop-up 3602 is displayed in response to the receiver clicking clean glass icon in FIG. 35.

FIG. 37 is a sample screen shot of an embodiment of a done button being selected 3702 on the note. For example, selecting done button 3702 closes the pop-up. Alternatively, selecting done button 3702 closes the pop-up and changes the state of the clean glass icon 2502 from uncompleted to completed.

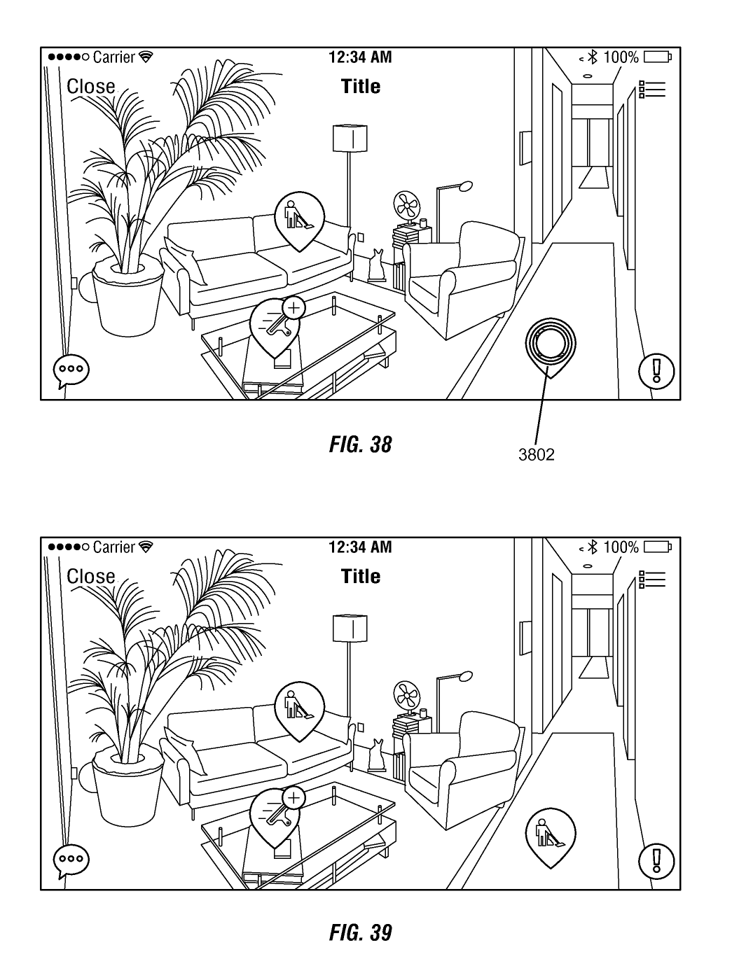

FIG. 38 is a sample screen shot of an embodiment of a different vacuum icon 3802 being selected.

FIG. 39 is a sample screen shot of an embodiment of the different vacuum icon in a different color, depicting that the related task is complete. In this example, all of the icons depict that the corresponding tasks are complete.

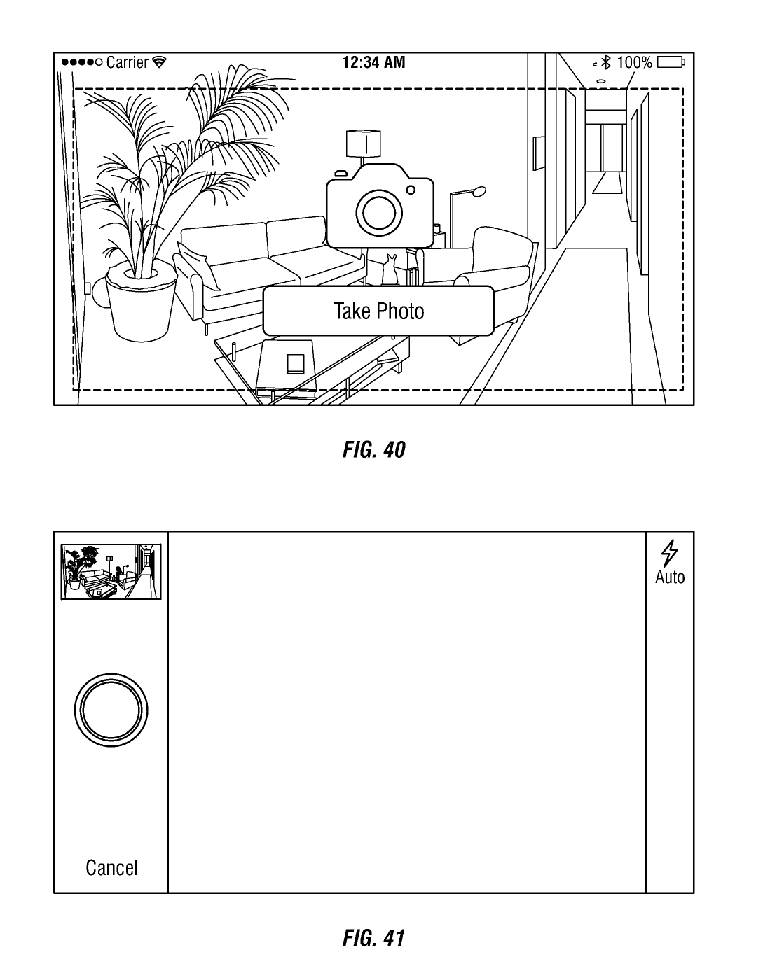

FIG. 40 is a sample screen shot of an embodiment of a take photo screen for the receiver to take a verification picture. For example, the application causes this take photo screen to be displayed in response to all tasks being completed in FIG. 39.

FIG. 41 is a sample screen shot of an embodiment of the screen from which the receiver takes a picture, the picture providing evidence that the tasks are completed. Space For example, the application causes the camera utility to be activated in response receiving user input from the receiver to take the photo. Once the verification photo has been taken, the application causes a copy of photo to be sent for delivery to the sender.

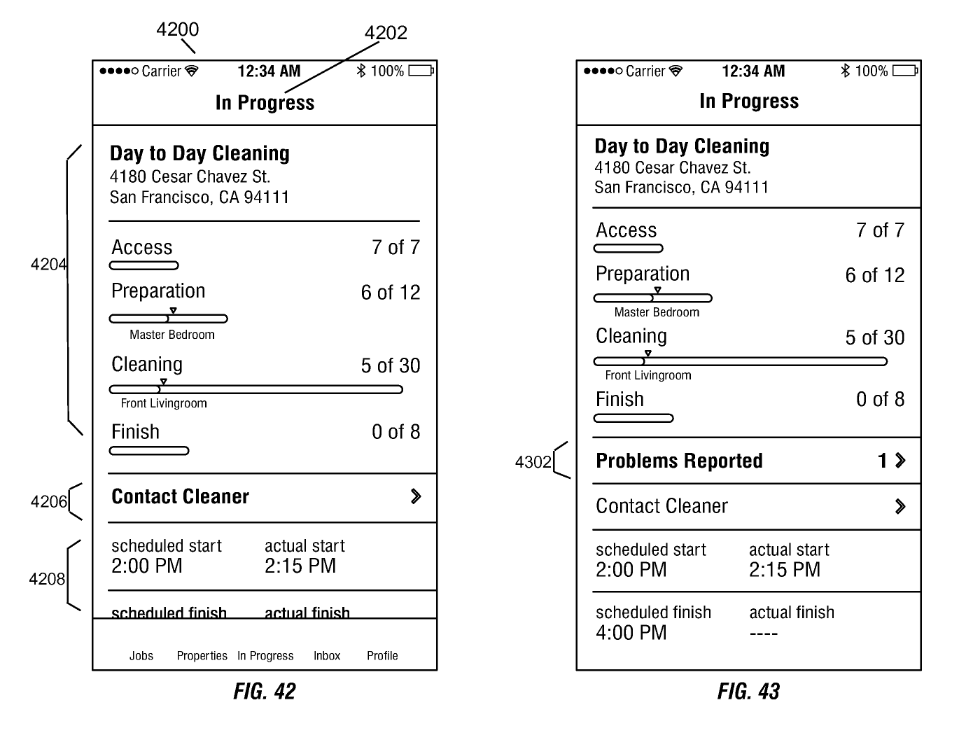

FIG. 42 is a sample screen shot of an embodiment of a sender's dashboard 4200 displaying an in progress screen 4202. Dashboard 4200 lists the sequential sections 4204 of the job. For example, the sequential sections are Access, Preparation, Cleaning, and Finish. A user input image for the receiver to contact the sender 4206 is displayed. Also displayed are metadata for 208, such as for example the scheduled start time in the actual start time of a task. In this example, particular data are displayed progress, including a bar and number indicators, to show many tasks of the total amount of tasks for the section have been completed.

FIG. 43 is a sample screen shot of an embodiment of an in progress screen displaying a user input field and data indicating that one problem has been reported 4302. The sender can select such user input field to view details about the problem. The problem was reported by the receiver through the application.

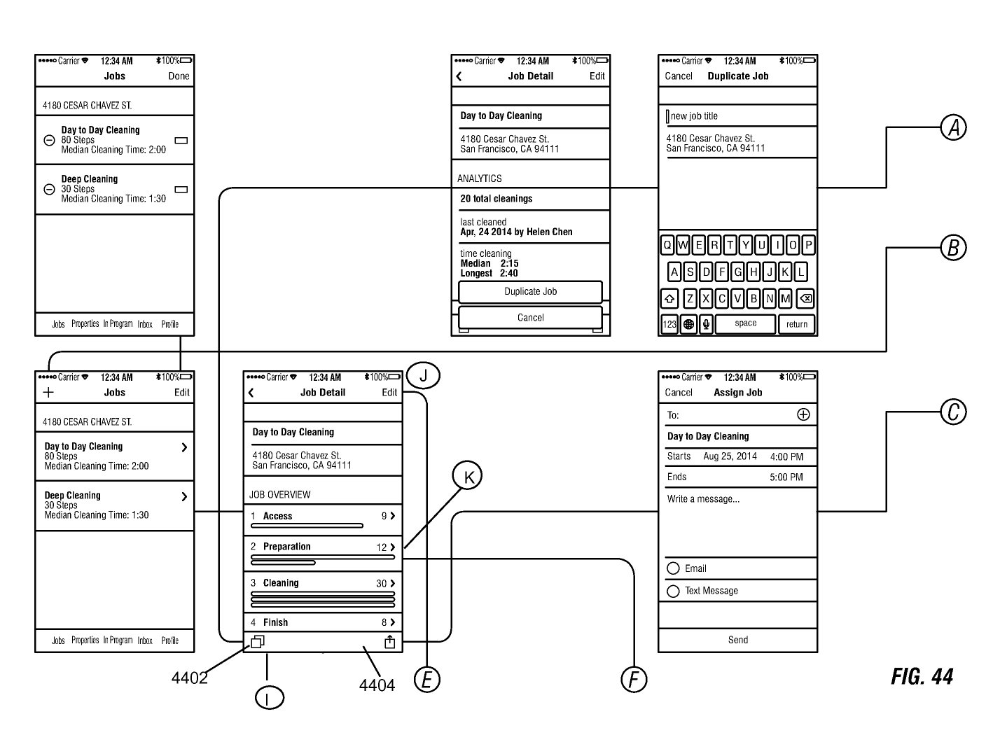

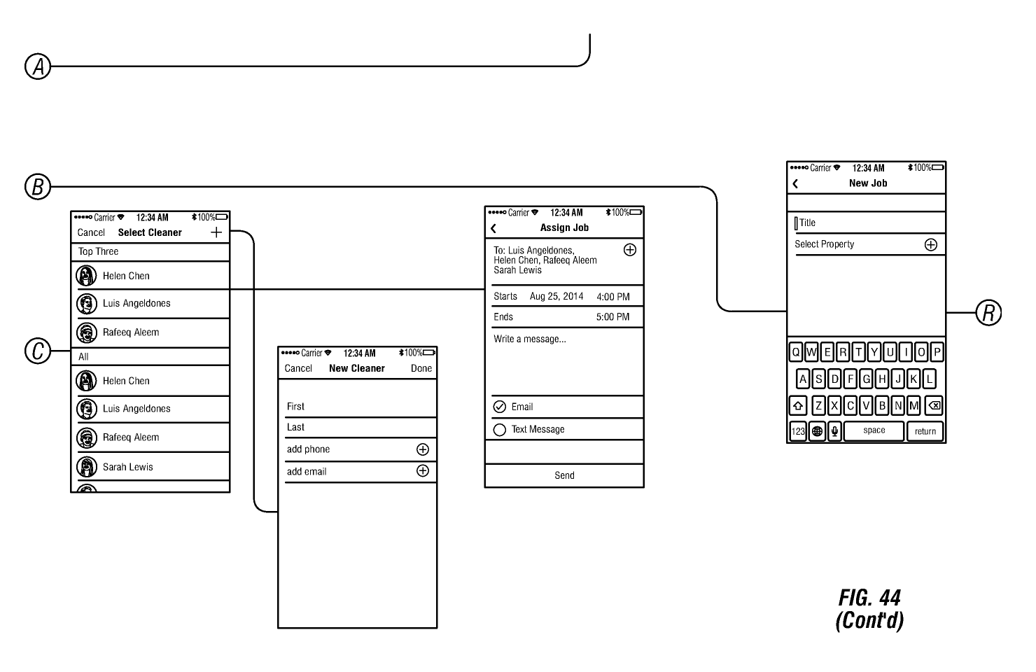

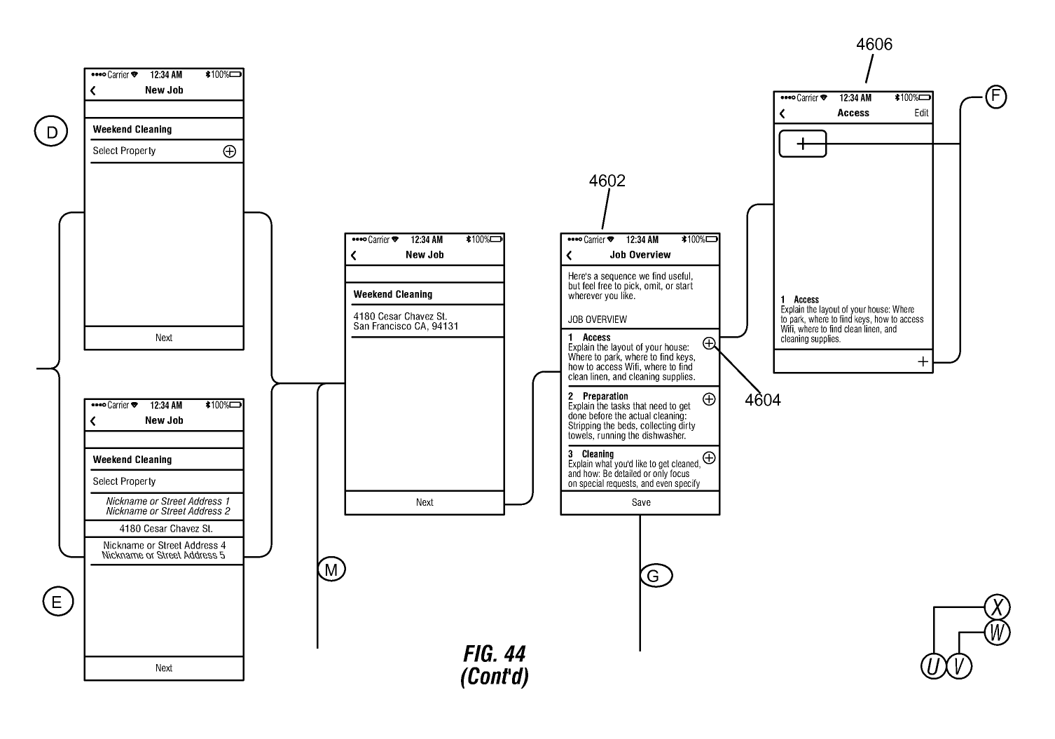

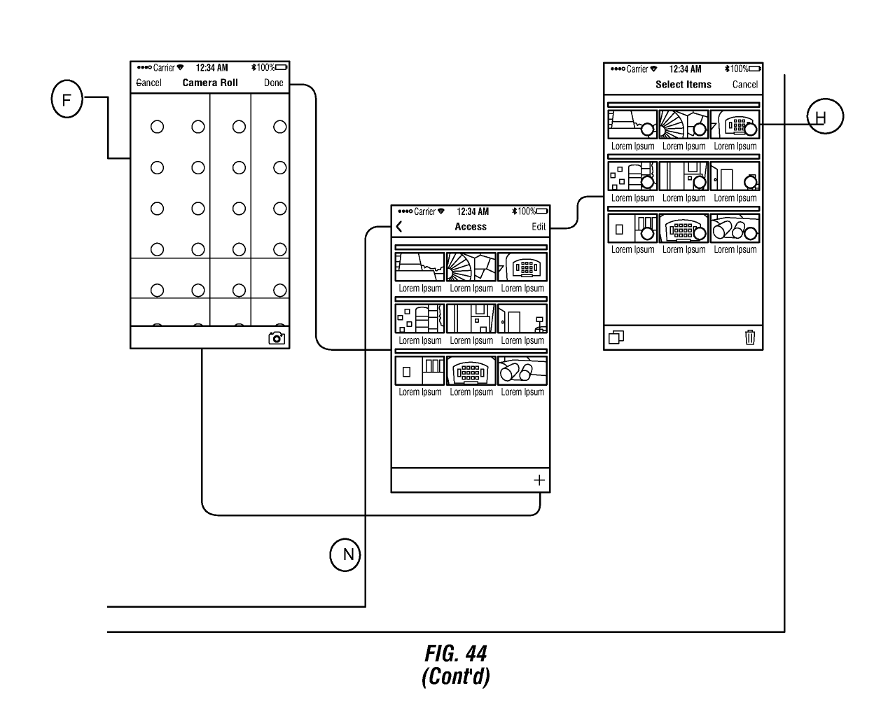

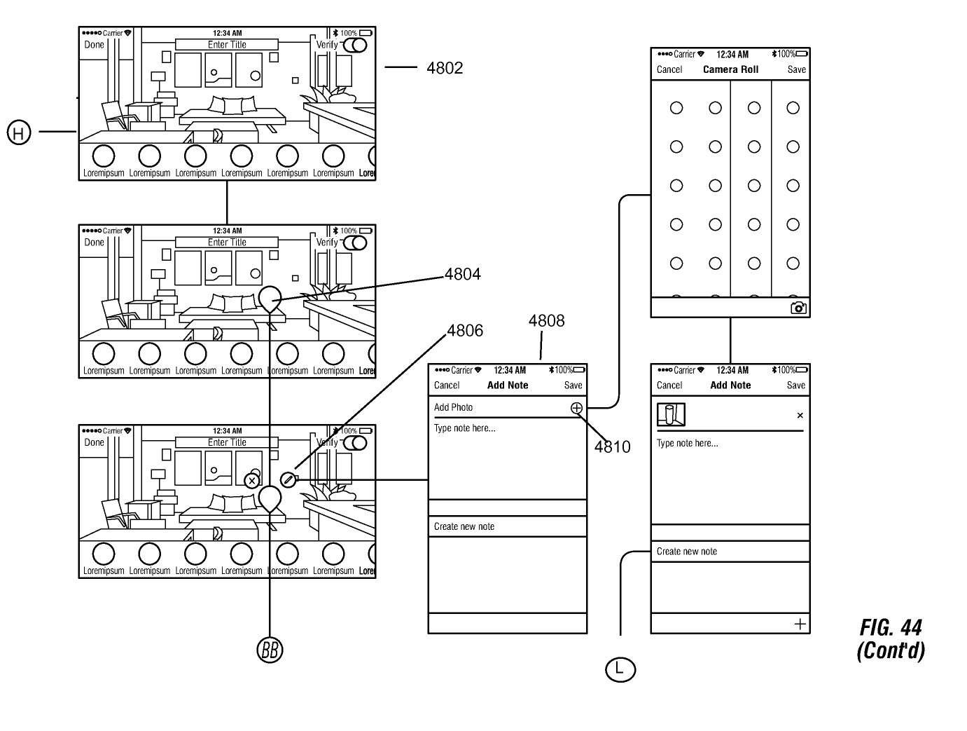

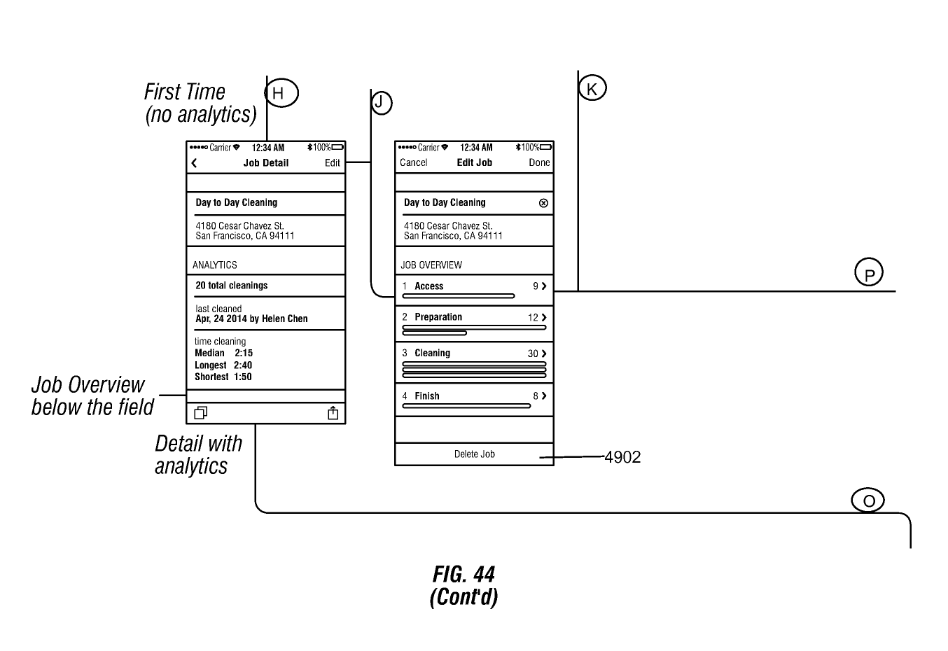

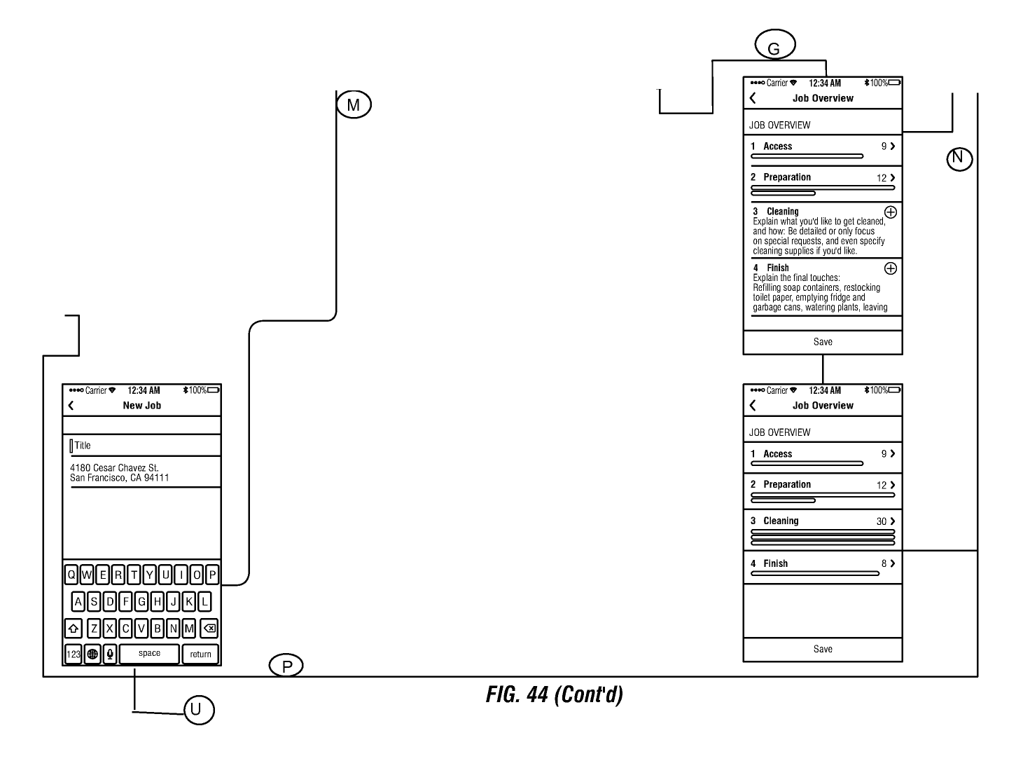

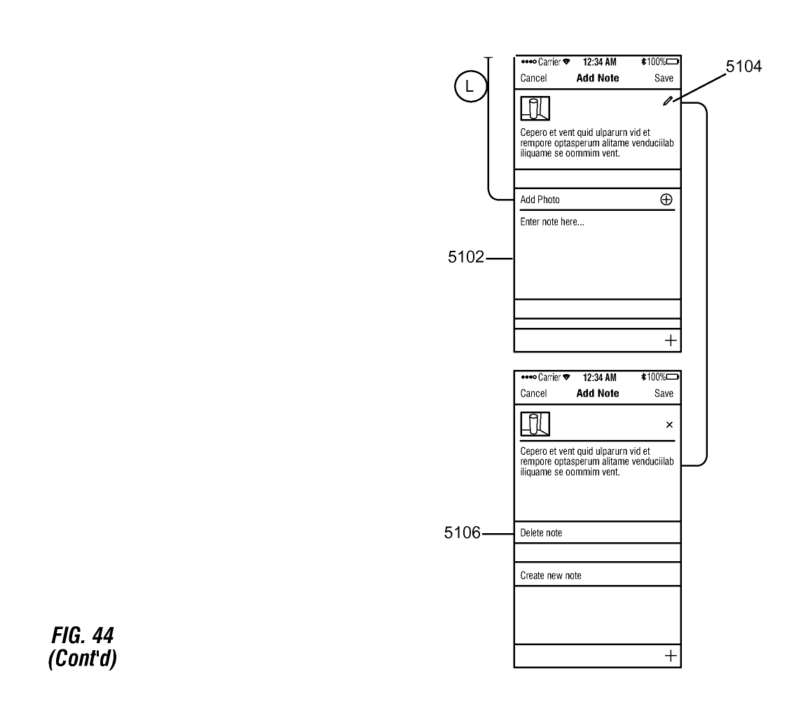

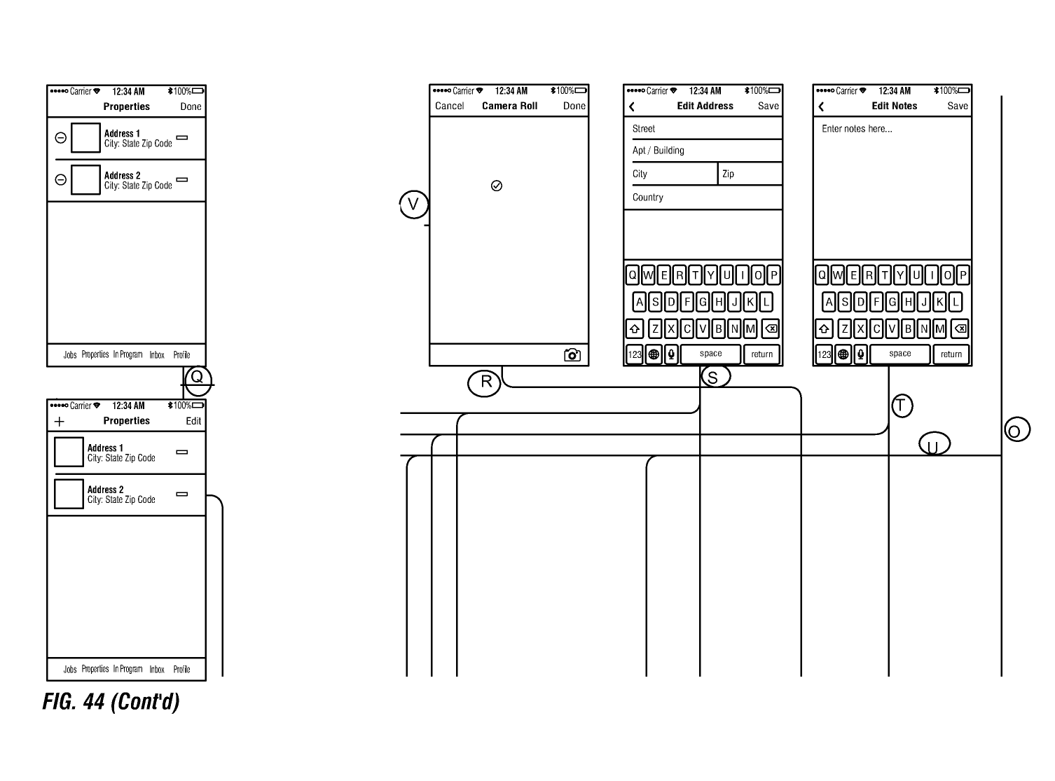

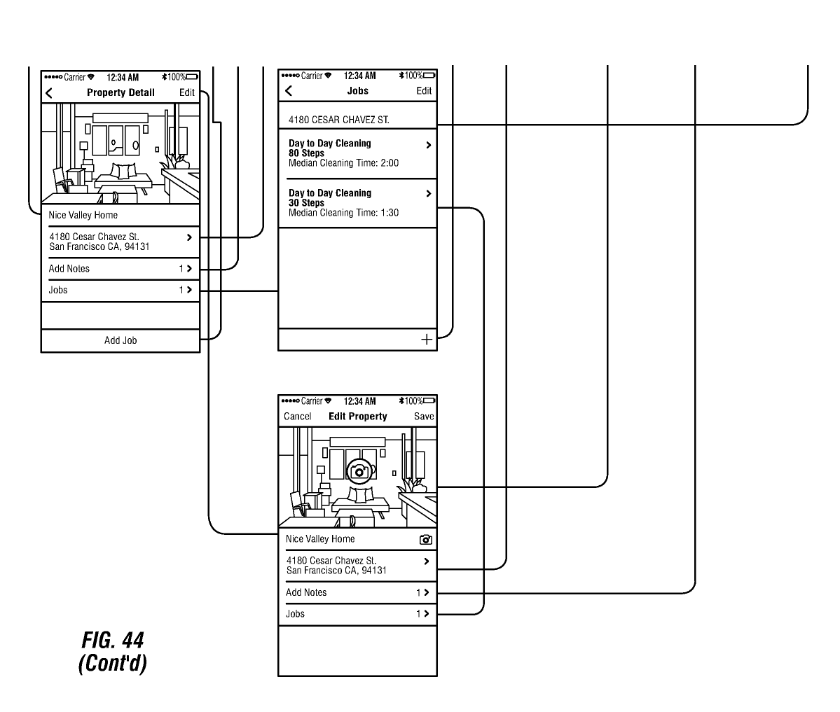

FIG. 44 illustrates a creation workflow diagram depicting various functionalities and various relationships therein, e.g., adding a job, assigning a job, and editing a property address, from the property owner perspective. Sequential steps of the workflow can be understood by following the output lines from each user interface screen. When a line extends beyond the figure it is designated with a circle capital letter. The extension of the same line can be found by finding the same circled capital letter on a different figure.

FIG. 44 shows a sample screen shot of part of an embodiment of a pictorial workflow diagram showing a jobs screen, a job detail screen, and a duplicate job screen, and an assign job screen. The job detail screen shows an active workflow and data depicting the progress of the workflow. On that job detail screen is a user input image 4402, which when activated enables the sender to duplicate that job. Duplicating the job saves the sender time in creating a second job. On that job detail screen is another user input image 4404, which when activated enables the sender to assign that job to a receiver. The application enables the sender to add the receiver's email address to send the job request via an email or the receiver's cell phone number to send the job request via a text message.

FIG. 44 also shows a sample screen shot of part of the pictorial workflow diagram showing a select cleaner screen, a new cleaner screen, an assign job screen, and a new job screen.

Also shown is a sample screen shot of part of the pictorial workflow diagram showing various new job screens, a job overview screen, and an access screen. At input line D, the sender doesn't yet have any entries from which to select a property to be cleaned. At input line E, the sender has an existing property entry. Screen job overview 4602 displays the sequential sections for the cleaning workflow. In response to the sender selecting a user input image 4604, the application causes an access screen 46062 display. Here, the sender is required to input an image corresponding to the set of tasks to access the property.

FIG. 44 also shows a sample screen shot of part of the pictorial workflow diagram showing a cameral roll screen, an access screen, and a select items screen.

Also shown is a sample screen shot of part of the pictorial workflow diagram showing screens on which the property owner can add a note, various add note screens, and a camera roll screen. A note can be added for one or more selected tasks as an option. A verify user input image is displayed, by which the sender can require a verification picture to be taken by the receiver. The sender drags and drops an icon 4804 onto the image. The application causes an interactive note element (e.g., an icon) 4806 to display. When the sender selects interactive note icon 4806 the application causes an add note window 4808 to display. The sender can indicate, for example by clicking a “+” icon 4810, to add a photo. The application causes a camera roll window including photos stored on the sender's device to display. The sender can choose a photo from such camera roll.

FIG. 44 also shows a sample screen shot of part of an embodiment of the workflow diagram showing a job detail screen and an edit job screen. For example, the sender can delete an existing job by selecting eight week job user input interface 4902.

FIG. 44 shows a sample screen shot of part of an embodiment of the workflow diagram showing a new job screen, and two views of a job overview screen.

Also shown is a sample screen shot of part of an embodiment of the workflow diagram showing a screen on which a user can add a note to a job and two views of an add note screen. The sender can add a second photo along with a second note. As well, the sender can edit a note, e.g., by selecting a user input image 5104. In edit mode, the sender can delete the note 5106.

FIG. 44 also shows a sample screen shot of part of an embodiment of the workflow diagram showing a properties screen, a camera roll screen, an edit address screen for editing an address, and an edit notes screen for editing a note. In an embodiment, the application enables the task-setting user (e.g., sender) to compose notes (e.g., instructions) in one language and then the application translates such notes such that task-performer (e.g., receiver) can view such notes in another language, the notes having been automatically translated by the application.

Also, FIG. 44 shows a sample screen shot of part of an embodiment of the workflow diagram showing a properties screen, a new property screen for adding a photo from the camera roll, a property detail screen, a jobs screen and an edit property screen.

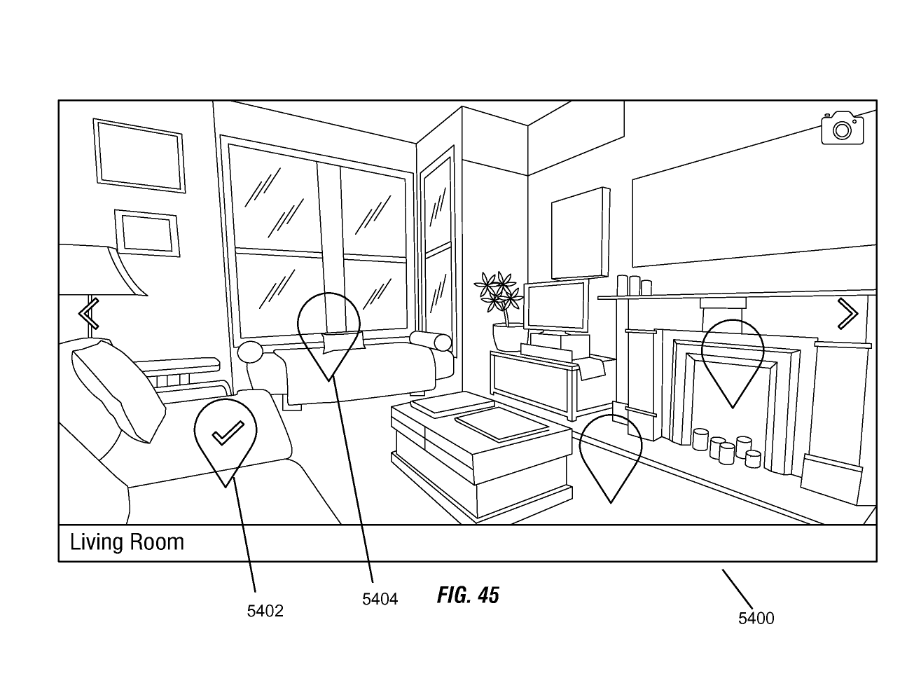

FIG. 45 is a sample screen shot of an image in a cleaning workflow 5400 from the receiver's perspective and viewed in landscape mode. This figure displays a task icon in the form of a teardrop 5404. In this example a completed task is indicated by the teardrop icon being filled in with a checkmark 5402.

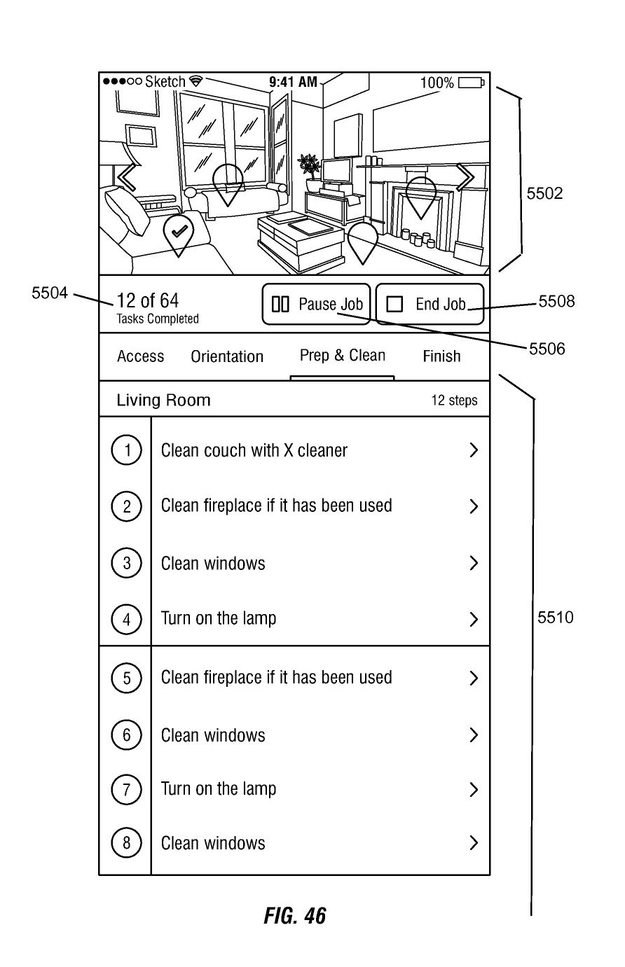

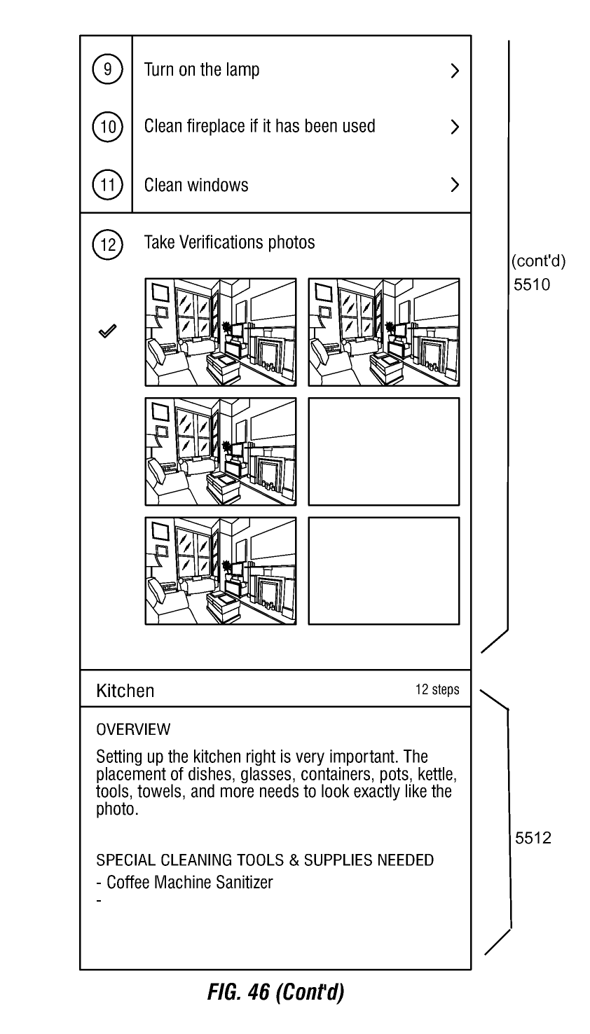

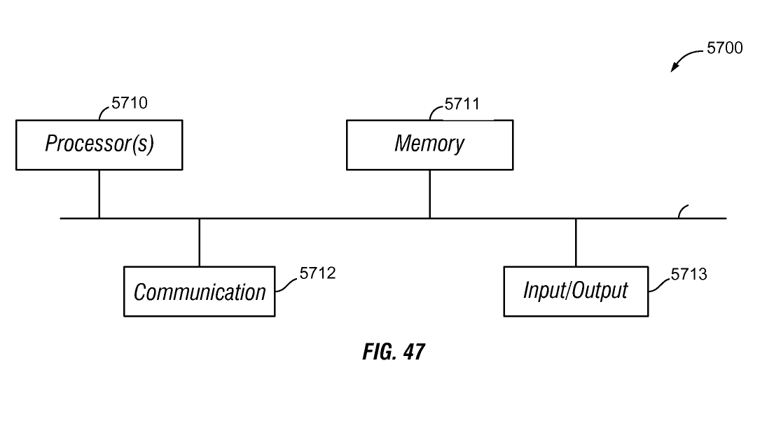

FIG. 46 is a sample screen shot of an image 5502 in a cleaning workflow when viewed in portrait mode, which shows at the top an image similar to that in FIG. 54 followed by items in a traditional checklist format. An output field 5504 displays updated data indicating the number of tasks completed out of the total number of tasks in the cleaning workflow. The application enables the receiver to pause the application 5506, for example when the receiver needs to pick up an emergency telephone call. As well, the application is configured to allow the receiver to end the job 5508. Below image 5502, is a traditional checklist for the 12 steps of the living room section 5510 of the workflow. Below the living room section of the workflow is another traditional checklist (not completely shown) for the 12 steps of the kitchen section 5512 of the workflow.

FIG. 47 is a high-level block diagram showing an example of a processing device 5700 that can represent any of the devices described above, such as device 5601, device 5602, and workflow application server 5606. As noted above, any of these systems may include one or more processing devices such as represented in FIG. 57, which may be coupled to each other via a network or multiple networks.

In the illustrated embodiment, the processing system 5700 includes one or more processors 5710, memory 5711, a communication device 5712, and one or more input/output (I/O) devices 5713, all coupled to each other through an interconnect 5714. The interconnect 5714 may be or include one or more conductive traces, buses, point-to-point connections, controllers, adapters and/or other conventional connection devices. The processor(s) 5710 may be or include, for example, one or more general-purpose programmable microprocessors, microcontrollers, application specific integrated circuits (ASICs), programmable gate arrays, or the like, or a combination of such devices. The processor(s) 5710 control the overall operation of the processing device 5700. Memory 5711 may be or include one or more physical storage devices, which may be in the form of random access memory (RAM), read-only memory (ROM) (which may be erasable and programmable), flash memory, miniature hard disk drive, or other suitable type of storage device, or a combination of such devices. Memory 5711 may store data and instructions that configure the processor(s) 5710 to execute operations in accordance with the techniques described above. The communication device 5712 may be or include, for example, an Ethernet adapter, cable modem, Wi-Fi adapter, cellular transceiver, Bluetooth transceiver, or the like, or a combination thereof. Depending on the specific nature and purpose of the processing device 5700, the I/O devices 5713 can include devices such as a display (which may be a touch screen display), audio speaker, keyboard, mouse or other pointing device, microphone, camera, etc.

Unless contrary to physical possibility, it is envisioned that (i) the methods/steps described above may be performed in any sequence and/or in any combination, and that (ii) the components of respective embodiments may be combined in any manner.

The techniques introduced above can be implemented by programmable circuitry programmed/configured by software and/or firmware, or entirely by special-purpose circuitry, or by a combination of such forms. Such special-purpose circuitry (if any) can be in the form of, for example, one or more application-specific integrated circuits (ASICs), programmable logic devices (PLDs), field-programmable gate arrays (FPGAs), etc.

Software or firmware to implement the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., read-only memory (ROM); random access memory (RAM); magnetic disk storage media; optical storage media; flash memory devices; etc.), etc.

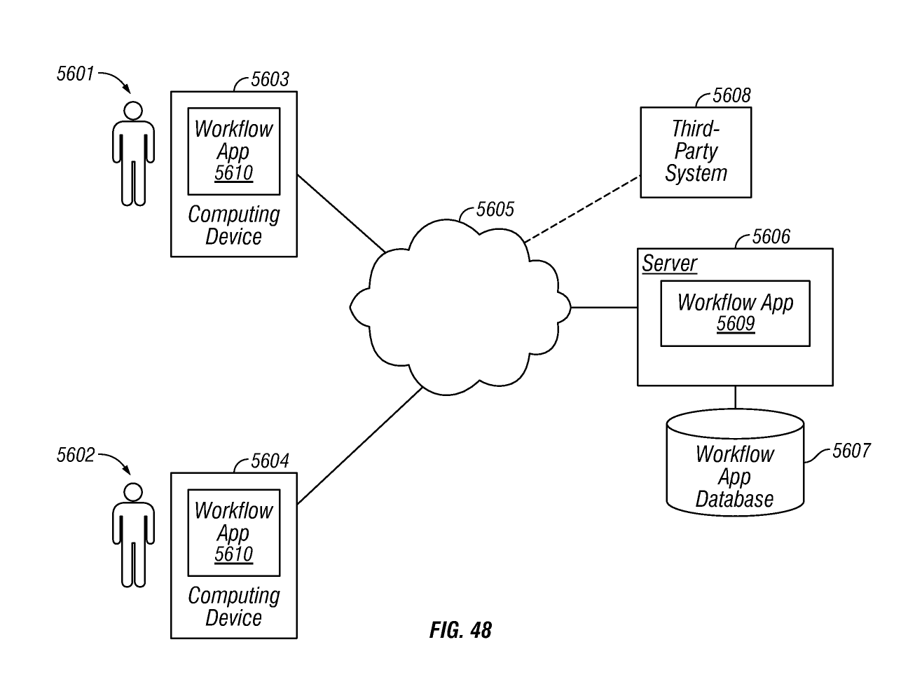

FIG. 48 illustrates an environment in which workflow process technology can be implemented. The environment includes a sender user 5601 (e.g., a workflow creator such as a property owner) and a device 5603 of user 5601. Device 5603 has stored thereon a workflow application 5610. The environment also includes a receiver user 5602 (e.g., a workflow consumer such as a cleaner) and a device 5604 of user 5602. Device 5602 also has stored thereon a copy of the workflow application 5610. A server device 5606 is included in the environment and runs a server version of the workflow application 5609. Server workflow application 5609 is coupled to a workflow application database 5607. Server workflow application 5609 can communicate with a third-party system 5608. Device 5603, device 5604, and server 5606 are communicatively coupled to each other through an internetwork 5605, which can be or include the Internet and one or more wireless networks (e.g., a WiFi network and or a cellular telecommunications network). Examples of third-party system 5608 include Airbnb and Lockitron. Examples of data stored in database 5607 include archive verification pictures and user registration data (e.g., the cell phone number of the receiver).

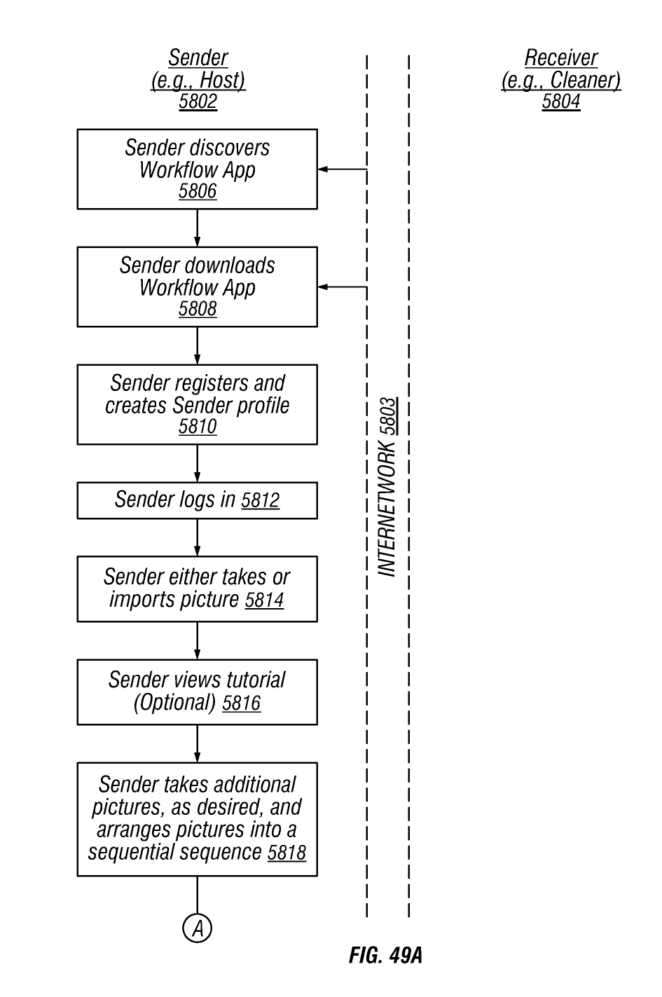

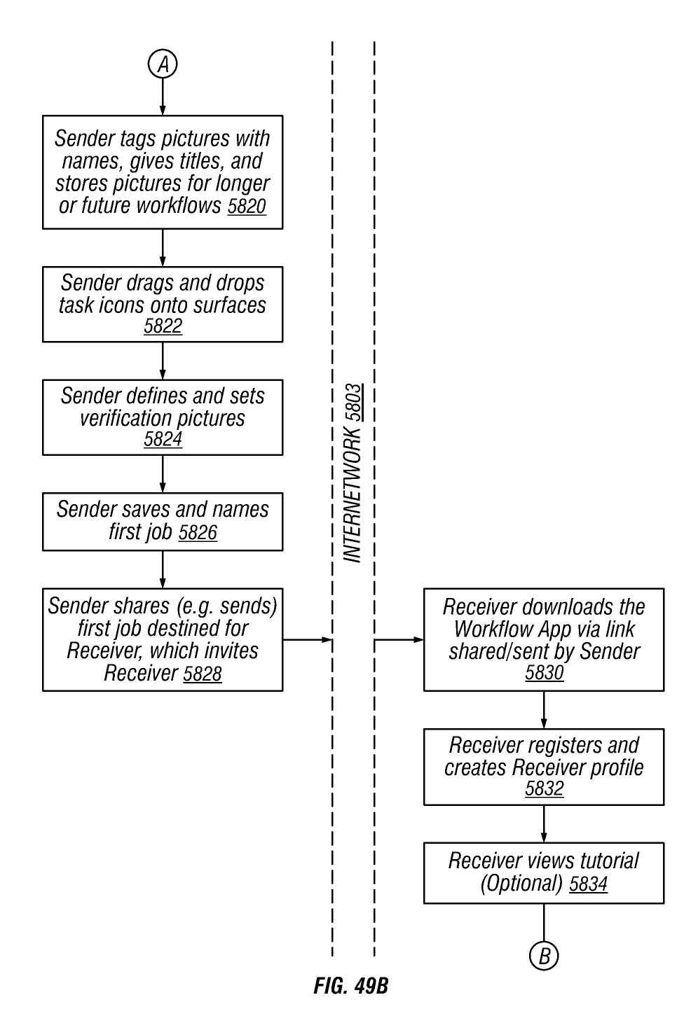

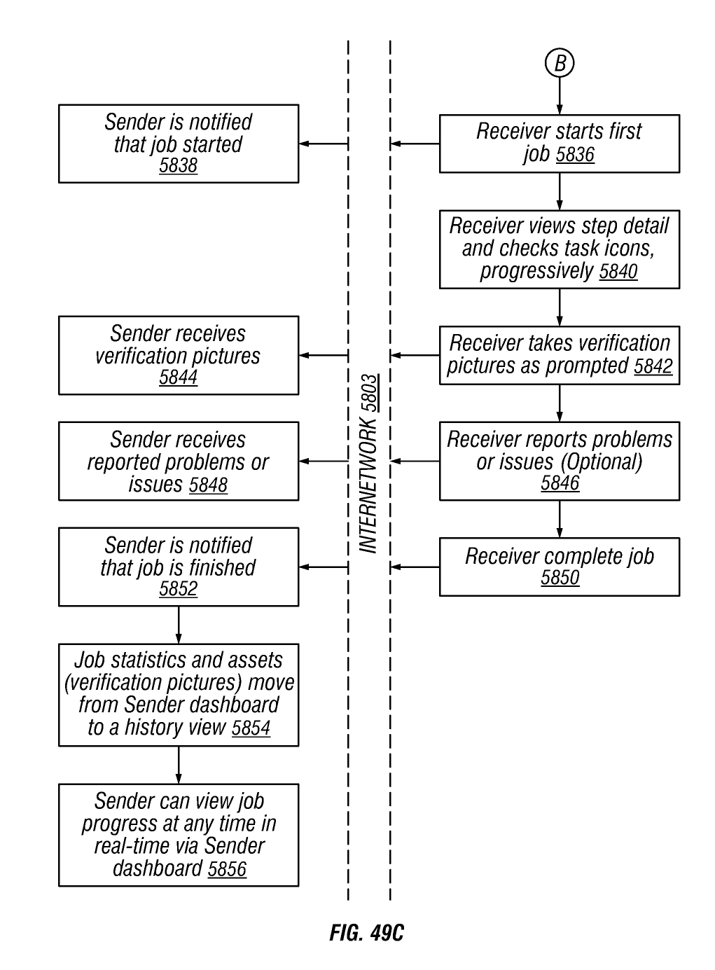

FIG. 49A-C illustrates an example of a workflow process from discovering the workflow application by a sender 5802 (“sender”) to the completion of a job, which was created by sender 5802, by a receiver 5804 (“receiver”). The sender and the receiver are communicatively coupled via an internetwork 5803. The workflow application is configured to enable sender 5802 and receiver 5804 to perform the following steps. The workflow process starts with sender discovering the workflow application (step 5806). The sender downloads the workflow application (step 5808). The sender registers into the workflow application and creates a sender profile within the workflow application (step 5810). The sender logs into the workflow application (step 5812). To create his workflow (also referred to herein as a workflow job), the sender either takes or imports a picture (step 5814). Optionally, the sender can view a tutorial (step 5816). The sender takes additional pictures, as desired, and can arrange the pictures into a sequential sequence (step 5818). The sender tags pictures with names, gives titles, and stores pictures for longer or future workflows (step 5820). The sender drags and drops task icons onto surfaces (step 5822). The sender defines and sets verification pictures (step 5824). When done, the sender saves and names this particular workflow as a first job (step 5826). The sender is ready to invite a receiver to accept a job request for this job. The sender shares (e.g., sends) the first job for delivery to the receiver, which effectively invites the receiver (step 5828). The receiver receives a notification such as for example a text message or an email containing a link to the workflow application with regard to the job request. From the text message board the email the receiver can press the link which enables the receiver to download the workflow application (if not already downloaded) from the workflow server (step 5830). From the downloaded application the receiver registers and creates a receiver profile (step 5832). Optionally, the receiver can view a tutorial (step 5834). When the receiver is ready, he can start the first job (step 5836). The workflow application causes a notification to be sent for delivery to the sender, the notification indicating that the job has started (step 5838). As the receiver performs the tasks of the workflow, the receiver checks each task icon to indicate the task is completed once he completes the task (step 5840). The receiver checks the task icons progressively as he performs the workflow. As well, the receiver can view step details for each task. As the receiver performs the workflow he takes verification pictures when prompted (step 5842). Each time for every verification picture taken, the sender receives a copy of the verification picture (step 584). Should the receiver desire to report a problem or an issue, the receiver can do so via the configured workflow application (step 5846). In response to the receiver reported a problem or communicating an issue, the workflow application causes the problem data or issue data to be sent for delivery to the sender (step 5848). When the receiver completes the job he indicates such for example by pressing a finish button on the application user interface (step 5850). In response to the receiver completes the job, the workflow application causes a message that the job is finished to be sent for delivery to the sender (step 5852). Post job processes take place on the sender's device as well as the workflow application server (step 5854). Such processes can include aggregating statistics about the job, e.g., the estimated complete time and the actual completion time and moving the completed job's data from the sender's dashboard to an archive storage for historical access and viewing. During the active workflow process the sender can view the job progress at any time in real-time via the sender's dashboard (step 5856).

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

1. A method comprising:
receiving, at an originating device, a user input indicative of a workflow the workflow including a set of corresponding tasks to be completed;
receiving, at the originating device, a user input indicative of a background image, the background image depicting a context of an area where a task of the corresponding tasks is to be performed or an object to which a corresponding task of the set of corresponding tasks is to be performed;
displaying, on a display of the originating device, the background image and a set of user input images, each user input image corresponding to a task in the set of corresponding tasks; and
receiving, at the originating device, a user input indicative of a placement a user input image from the set of user input images onto a user-determined location of the background image to indicate that the task corresponding to the user input image is to be performed at the area corresponding to the user-determined location of the background image;
wherein each user input image is capable of being changed from one state to another state to indicate the status of the corresponding task.

2. The method of claim 1, wherein the originating device is a stationary or mobile computing device, said mobile computing device comprising any of: mobile phone, tablet, wearable, head-up display, or another device intended to convey information to its user.

3. The method of claim 1, wherein the user input image is a picture icon with a picture indicative of the corresponding task.

4. The method of claim 1, wherein the background image is any of or any combination of: a photo, a diagram, a map, or a screen shot.

5. The method of claim 1, wherein the set of user input images is overlaid on top of the background image.

6. The method of claim 1, further comprising:
displaying, on the display of the originating device, a note user input element corresponding to a selected displayed user input image of the set of displayed user input images, said note user input element configured to accept informational data from a user about the corresponding task.

7. The method of claim 1, further comprising:
storing, at the originating device, the background image and the placed user input image as a complete workflow; and
sending, by the originating device, the complete workflow for delivery to a receiving device of a task-performing user as a request for the task-performing user to perform the completed workflow;
the receiving device is a stationary or mobile computing device, said mobile computing device comprising any of: mobile phone, tablet, wearable, head-up display, or another device intended to convey information to its user.

8. The method of claim 7, further comprising:
receiving, in real-time by a dashboard processor at the originating device, a notification message originating from the receiving device that a user input image from the delivered complete workflow changed from said one state to said another state.

9. The method of claim 8, further comprising:
displaying, by the dashboard processor at the originating device, a real-time progress visual indicator reflecting a cumulative aggregation of changed states of a plurality of user input images from the delivered complete workflow.

10. The method of claim 8, further comprising:
further receiving from the receiving device metadata to be used for measurement and analytical purposes.

11. The method of claim 10, wherein the metadata further includes time of a start of task, time of a completion of said task, a date when the task was completed, location data indicative of the location where the task was completed, or the identity of the task-performing user.

12. The method of claim 7, further comprising:
receiving, at the originating device, a verification picture originating from the receiving device, the verification picture showing the area after the corresponding tasks have been performed.

13. The method of claim 7, further comprising:
receiving in real-time, at the originating device, informational data originating from the receiving device, said informational data depicting a problem or issue; and
displaying, on the display of the originating device, in a report problem area, rendered data from said informational data.

14. The method of claim 1, wherein the workflow is a cleaning workflow, the workflow being divided into sequential sections, each section including a subset of tasks from the corresponding tasks to be completed, and said sequential sections comprise:
an access and orientation section for instructions on how to get into a property and where to find certain items;
a preparation section for instructions on how to strip/make beds, exchange towels, and laundry;
a cleaning section for instructions on how to clean the property; and
a finishing section for instructions on how to lock the property, present the property, and complete final checklists.

15. The method of claim 1, wherein when the originating device is in landscape mode, the dashboard processor at the originating device is configured to display a background image, wherein the background image includes the placed user input images, the placed user input images visually indicating whether the corresponding tasks have been completed; and
when the originating device is in portrait mode, the dashboard processor at the originating device is configured to display the background image as in landscape mode and is configured to display below the background image a list of the tasks corresponding to the workflow.

16. A method comprising:
receiving, at a receiving device of a task-performing user, a workflow originating from an originating device of a task-setting user for the task-performing user to complete, the workflow comprising a background image of a context of an area where a set of tasks are to be performed and a set of user input images, each said user input image corresponding to a task, of said set of tasks, to be completed in the area and capable of being changed from one state to another state to reflect the status of the task;
receiving, at the receiving device, a user input indicating that the workflow has started;
responsive to receiving the user input indicating that the workflow has started, sending, by the receiving device, a notification message destined for the task-setting user at the originating device that the workflow has started;
receiving, at the receiving device, user input indicating that a user input image of the set of user input images has been changed from said one state to said another state; and
when the tasks of the workflow are completed, sending, by the receiving device, a notification message destined for the originating device to inform the task-setting user that the workflow is complete.

17. The method of claim 16, further comprising:
prompting, by the receiving device and when configured by the task-setting user, the task-performing user to take a verification picture, said verification picture showing the area after the corresponding tasks have been performed;
taking, by a camera processor at the receiving device, the verification picture; and
responsive to the camera processor taking the verification picture, transmitting, by the receiving device, the verification picture for delivery to the originating device.

18. The method of claim 16, wherein the originating device or the receiving device is a stationary or mobile computing device, said mobile computing device comprising any of: mobile phone, tablet, wearable, head-up display, or another device intended to convey information to its user

19. The method of claim 16, wherein the user input image is a picture icon with a picture indicative of the corresponding task.

20. The method of claim 16, wherein the background image is any of or any combination of: a photo, a diagram, a map, or a screen shot.

21. The method of claim 16, wherein the set of user input images is overlaid on top of the background image.

22. The method of claim 16, further comprising:
displaying, on the display of the receiving device, a note element corresponding to displayed user input image of the set of displayed user input images, said note element configured to display informational data about the corresponding task.

23. The method of claim 16, further comprising:
when each said state of a user input image changes to said another state, appending, by the receiving device, metadata to information stored about said user input image, said metadata to be used for measurement and analytical purposes.

24. The method of claim 23, wherein the metadata further includes time of a start of task, time of a completion of said task, a date when the task was completed, location data indicative of the location where the task was completed, or the identity of the task-performing user.

25. The method of claim 16, further comprising:
displaying, by the receiving device, a report problem input area for the task-performing user to report a problem destined for the task-setting user;
receiving, by the receiving device from the report problem input area, user input indicative of problem data relating to the problem; and
transmitting, by the receiving device, said problem data destined for the task-setting user to communicate the problem to the task-setting user.

26. The method of claim 16, wherein when in landscape mode, the receiving device is configured to display the background image and the set of user input images; and
when in portrait mode, the receiving device is configured to display the background image as in landscape mode and is configured to display below the background image a list of tasks corresponding to the workflow.

27. An apparatus comprising:
a user input component configured to receive from a task-setting user data indicative of a selection of a workflow, the workflow including a set of corresponding tasks intended to be completed by a task-performing user;
an import component configured to import a background image depicting a context of an area where the set of corresponding tasks is to be performed;
a user interface component configured to cause the background image and a set of user input images to be displayed on a display to the task-setting user, each user input image corresponding to a task from the set of corresponding tasks that is intended to be performed by the task-performing user;
the user interface component further configured to enable each said user input image to be changed from one state to another state to indicate a status of the corresponding task;
the user interface component further configured to enable the task-setting user to place a user input image from the displayed set of user input images to a user-determined location on the background image to indicate where in the area the corresponding task is to be performed;
a saving component configured to save the background images, each said placed user input image, and each said corresponding user determined location to a completed workflow intended for the task-performing user:
a networking interface configured to transmit the completed workflow destined for the task-performing user; and
the networking interface being further configured to receive a message indicative of a user input image from the completed workflow having changed from said one state to said another state to inform the task-setting user that the status of corresponding task has changed.

28. The apparatus of claim 27, wherein the apparatus is a stationary or mobile computing device, said mobile computing device comprising any of: mobile phone, tablet, wearable, head-up display, or another device intended to convey information to its user.

29. The apparatus of claim 28, wherein when the mobile computing device is in landscape mode, the mobile computing device is configured to display the background image and the set of user input images; and
when the mobile computing device is in portrait mode, the mobile computing device is configured to display the background image and the user input images as in landscape mode and further is configured to display, below, a list of tasks corresponding to the workflow.

30. The apparatus of claim 27, wherein the user input image is a picture icon with a picture indicative of the corresponding task.

31. The apparatus of claim 27, wherein the background image is any of or any combination of: a photo, a diagram, a map, or a screen shot.

32. The apparatus of claim 27, wherein the set of user input images is overlaid on top of the background image.

33. The apparatus of claim 27, wherein the user interface component is further configured to display a note user input element corresponding to a selected displayed user input image of the set of displayed user input images, said note user input element being configured to accept additional information about the task from the task-setting user intended for the task-performing user.

34. The apparatus of claim 33, wherein the additional information include instructions further explaining or modifying the task.

35. The apparatus of claim 27, wherein the networking interface transmits the completed workflow via email or text message.

36. The apparatus of claim 27, wherein the user interface component is further configured to set a condition intended for the task-performing user, the condition indicative of requiring that a verification picture be taken after selected tasks of the set of tasks have been completed.

37. The apparatus of claim 27, wherein the user interface component is further configured to set a condition intended for the task-performing user, the condition indicative of requiring that a verification picture be taken in response to a time of day, a time elapsed, a location of a receiving device of the task-performing user, a completion of certain tasks of the completed workflow, or any combination thereof, and wherein the receiving device is a stationary or mobile computing device, said mobile computing device comprising any of: mobile phone, tablet, wearable, head-up display, or another device intended to convey information to its user.

38. The apparatus of claim 27, wherein in the message indicating that the user input image changed to a completed state further comprises metadata about said completed corresponding task.

39. The apparatus of claim 38, further comprising:
a recording component configured to record the metadata;
an analysis component configured to compare metadata corresponding to completed tasks by different task-performing users or to compare metadata corresponding to completed tasks by a same task-performing user; and
an output component configured to output information intended for the task-setting user, the outputted information comprising the compared metadata corresponding to completed tasks by the different users or the compared metadata corresponding to completed tasks by the same task-performing user.

40. The apparatus of claim 38, wherein the metadata includes at least one of or any combination of: actual and estimated time data, actual and estimated date data, location data of said completed corresponding task, and identity of the task-performing user.

41. The apparatus of claim 27, wherein:
the network interface is further configured to receive in real-time informational data depicting a problem or issue originating from the task-performing user; and
the user interface component is further configured to display, in a report problem area on the display, rendered data from said informational data.
